(19) United States
(12) Patent Application Publication
(10) Pub. No.: US 2012/0009385 A1
(43) Pub. Date: Jan. 12, 2012

(54) RESIN COMPLEX AND LAMINATE

(75) Inventors: Masataka Satou, Ashigara-kami-gun (JP); Mitsuyuki Tsurumi, Ashigara-kami-gun (JP)

(73) Assignee: FUJIFILM CORPORATION, Minato-ku, Tokyo (JP)

(21) Appl. No.: 13/125,611

(22) PCT Filed: Oct. 20, 2009
(86) PCT No.: PCT/JP2009/068068

§ 371 Date: Apr. 22, 2011

(30) Foreign Application Priority Data
Oct. 24, 2008 (JP) 2008-274589

(51) Int. Cl. B32B 27/00; C09D 133/08; B32B 5/00; C08L 33/08

(52) U.S. Cl. 428/141; 525/217; 428/500

(57) ABSTRACT

A resin complex which is capable of being plated, is highly hydrophobic, and has excellent molding properties and good adhesion to a plated layer, a laminate including a layer of the resin complex, and a method of manufacturing the laminate are provided. The resin complex capable of being plated includes a hydrophobic compound A having a functional group capable of interacting with a plating catalyst, its precursor or a metal, and a hydrophobic resin B incompatible with the hydrophobic compound A. The resin complex has a phase-separated morphology in which the hydrophobic compound A forms a dispersed phase and the hydrophobic resin B forms a continuous phase and the hydrophobic compound A is exposed on at least part of a surface of the resin complex.

### TECHNICAL FIELD

The present invention relates to a resin complex capable of being plated, a laminate including a layer made of the resin complex capable of being plated, and a method of manufacturing the laminate.

### BACKGROUND ART

Recently, the technique of forming a plated layer on a surface of resin molded articles has been utilized in various fields for functional or decorative purposes and attempts have been made to improve the technique. The technique of forming a plated layer on an insulating film is used in, for example, printed circuit boards employed in electronic devices and electromagnetic interference shielding films employed in plasma displays. The resin moldings such as automobile parts are plated with metals such as copper and nickel to add a touch of class and an aesthetic value thereto.

In general, a surface roughening treatment for roughening a resin surface is performed to improve the adhesion between the resin surface and the plated layer. The adhesion between the resin and the plated layer is enhanced by the anchor effect produced by the roughened surface.

On the other hand, the surface roughness made it difficult for the resin surface to have a metallic luster. In addition, when applied to a printed circuit board, a patterned metal film formed by plating on a surface of a resin substrate also suffered from poor radio frequency characteristics due to the roughness of the interface with the substrate.

What is more, roughening of the substrate surface required treatment of the substrate surface with a strong acid such as chromic acid or permanganic acid and also led to environmental problems such as liquid waste disposal.

Then, use of a polar group-containing hydrophilic resin is proposed as a technique for solving these problems (Patent Literatures 1 and 2, and Non-Patent Literature 1). More specifically, in Patent Literatures 1 and 2, a resin molded body containing a polysaccharide such as starch and a water-soluble substance such as propylene glycol is used to enhance the adhesion to the plated layer formed on a surface of the resin molded body. In Non-Patent Literature 1, the adhesion between the substrate and the plated layer is enhanced without roughening the substrate surface by performing a surface treatment for forming a surface graft polymer having a polar group on the substrate surface.

### CITATION LIST

### Patent Literature

Patent Literature 1: JP 2008-81838 A
Patent Literature 2: JP 2008-57033 A

### Non-Patent Literature

Non Patent Literature 1: Advanced Materials, 2000, Vol. 20, 1481-1494

### SUMMARY OF INVENTION

### Technical Problems

However, use of the polar group-containing hydrophilic resin as described in Patent Literatures 1 and 2 and Non-Patent Literature 1 easily causes absorption or desorption of moisture due to changes in the temperature and humidity although the adhesion to the plated layer is improved. As a result, deformation of the plated layer formed and the resin itself occurred.

In cases where two types of resins different in nature, that is, a hydrophilic resin and a hydrophobic resin were used in combination as described in Patent Literatures 1 and 2, a versatile molding technique such as a coating process which involves molding a resin dissolved in a solvent into a predetermined shape could not be used because there was no solution in which both the resins could be well dissolved. In addition, the resulting molded article had a phase-separated morphology composed of a hydrophilic resin and a hydrophobic resin and the respective domain phases were considerably enlarged due to the low compatibility between the resins. Therefore, regions where the adhesion strength between the resin and the plate layer was high and regions where the adhesion strength was low were present side by side to cause uneven adhesion strength.

In addition, in the case of a resin molded body containing a hydrophilic resin, the hydrophilic resin increased the dielectric constant and reduced the insulation performance to thereby limit the application to members which may be used in electronic devices such as printed circuit boards having micro wiring as described above.

In view of the situation as described above, an object of the invention is to provide a resin complex which is capable of being plated, is highly hydrophobic, and has excellent molding properties and good adhesion to a plated layer. Another object of the invention is to provide a laminate comprising a layer of the resin complex. Still another object of the invention is to provide a method of manufacturing the laminate.

### Solution to Problems

The inventors of the invention have made an intensive study to solve the above problems and as a result found that the objects of the invention are achieved by the characteristic features described in (1) to (9) below.

(1) A resin complex capable of being plated, which comprises: a hydrophobic compound A having a functional group capable of interacting with a plating catalyst, its precursor or a metal, and a hydrophobic resin B incompatible with the hydrophobic compound A, wherein the resin complex has a phase-separated morphology in which the hydrophobic compound A forms a dispersed phase and the hydrophobic resin B forms a continuous phase and the hydrophobic compound A is exposed on at least part of a surface of the resin complex.
(2) The resin complex according to (1), wherein the dispersed phase comprising the hydrophobic compound A has an average diameter at the surface of the resin complex of 0.01 to 500 μm.
(3) The resin complex according to (1) or (2), further comprising the plating catalyst or its precursor.
(4) The resin complex according to any one of (1) to (3), wherein the plating catalyst or its precursor is capable of existing within a depth of 2 μm from the surface of the resin complex.
(5) The resin complex according to any one of (1) to (4), wherein the hydrophobic compound A is a hydrophobic polymer A′ having a recurring unit represented by general formula (1):

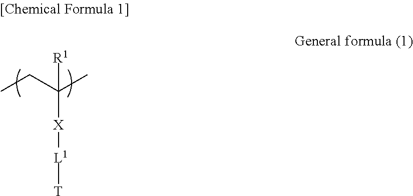

(wherein R¹ is a hydrogen atom or an optionally substituted alkyl group, X is a single bond or an optionally substituted divalent organic group, L¹ is an optionally substituted divalent organic group, and T is a functional group capable of interacting with the plating catalyst, its precursor or the metal).
(6) A laminate comprising a substrate; and a resin complex layer comprising the resin complex according to any one of (1) to (5) and formed on the substrate.
(7) The laminate according to (6), wherein a surface portion of the resin complex layer on which a plated layer is to be formed has a mean surface roughness Rₐ of 0.01 to 1.5 μm.
(8) The laminate according to (6) or (7), further comprising the plated layer formed on the resin complex layer.
(9) A method of manufacturing a laminate having a plated layer, the method comprising:

a resin complex layer-forming step for forming on a substrate a resin complex layer including a hydrophobic compound A having a functional group capable of interacting with a plating catalyst, its precursor or a metal, and a hydrophobic resin B incompatible with the hydrophobic compound A, the hydrophobic compound A being exposed on at least part of a surface of the resin complex layer which does not contact the substrate;

a catalyst applying step for applying the plating catalyst or its precursor to the resin complex layer; and

a plating step for forming a plated layer on the resin complex layer having the plating catalyst or its precursor as obtained in the catalyst applying step.

### Advantageous Effects of the Invention

The invention can provide a resin complex which is capable of being plated, is highly hydrophobic, and has excellent molding properties and good adhesion to a plated layer, a laminate comprising a layer of the resin complex, and a method of manufacturing the laminate.

The resin complex capable of being plated according to the invention may also be used as it is or be used as a laminate having the resin complex formed on a separate substrate.

### BRIEF DESCRIPTION OF DRAWINGS

FIG. 1 is a schematic cross-sectional view showing an embodiment of a laminate according to the invention.

FIG. 2 is a cross-sectional view taken along the line II-II of the laminate shown in FIG. 1.

FIG. 3 is an optical micrograph of the surface of a resulting resin complex layer.

### DESCRIPTION OF EMBODIMENTS

The resin complex and the laminate including the layer of the resin complex according to the invention are described below in detail with reference to the preferred embodiments shown in the accompanying drawings.

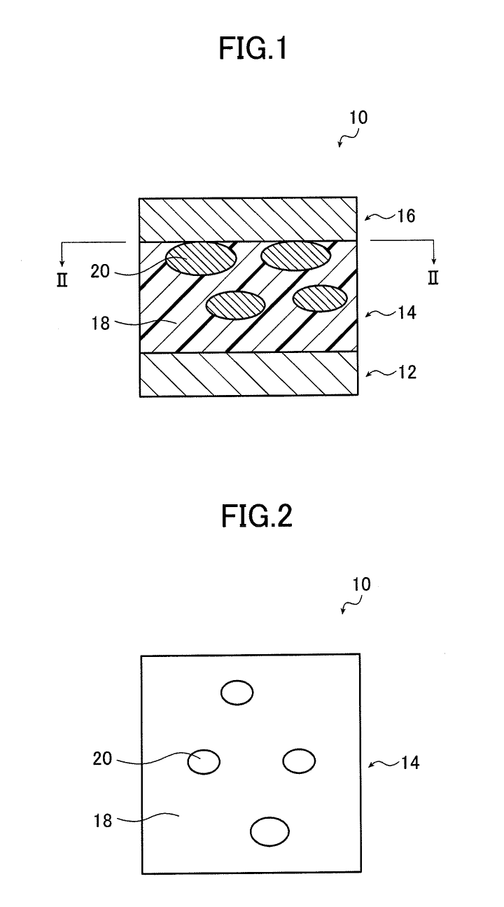

FIG. 1 is a schematic cross-sectional view showing an embodiment of a laminate including a resin complex layer according to the invention.

A laminate 10 shown in FIG. 1 is obtained using the resin complex of the invention and is of a laminated structure in which a substrate 12, a resin complex layer 14 and a plated layer 16 are stacked in this order. As shown in FIG. 1, the resin complex layer 14 includes a continuous phase 18 made of a hydrophobic resin B and a dispersed phase 20 which is present in the continuous phase 18 in a dispersed manner and is made of a hydrophobic compound A. The thicknesses of the substrate 12, the resin complex layer 14 and the plated layer 16 are not limited to the case shown in FIG. 1.

FIG. 2 is a cross-sectional view taken along the line II-II of the laminate 10 of the invention.

On the upper surface side of the resin complex layer 14 shown in FIG. 2, a phase-separated morphology is formed which includes the continuous phase 18 made of the hydrophobic resin B and the dispersed phase 20 present in the continuous phase 18 in a dispersed manner and made of the hydrophobic compound A, the dispersed phase 20 made of the hydrophobic compound A being exposed on the surface to form an island shape.

The layers making up the laminate 10 of the invention are first described.

### [Substrate]

The substrate 12 is not particularly limited as long as it supports the resin complex layer 14 and the plated layer 16 stacked thereon and is preferably a dimensionally stable sheet. Examples thereof include paper; paper laminated with plastic materials such as polyethylene, polypropylene and polystyrene; metal sheets made of, for example, aluminum, zinc and copper; plastic films made of, for example, cellulose diacetate, cellulose triacetate, cellulose propionate, cellulose butyrate, cellulose acetate, cellulose nitrate, polyethylene terephthalate, polyethylene, polystyrene, polypropylene, polycarbonate, polyvinyl acetal, polyimide, epoxy, bismaleimide resin, polyphenylene oxide, liquid crystal polymer, and polytetrafluoroethylene; and paper or plastic films on which any of the foregoing metals is laminated or vapor-deposited. The substrate 12 that may be used in the invention is preferably made of a glass epoxy material, polyimide, polycarbonate, ABS resin, polyamide resin, phenol resin, polyurea resin, polyurethane resin, or epoxy resin.

The laminate having the plated layer in the invention may be applied to semiconductor packages and various electrical circuit boards. An insulating resin-containing substrate as mentioned below is preferably used in these applications. More specifically, a substrate made of an insulating resin and a substrate having an insulating resin layer formed on the surface thereof are preferably used.

A known insulating resin composition is used to obtain the substrate made of an insulating resin or the insulating resin layer. In addition to the resin as the main component, such insulating resin composition may further contain various additives according to the intended purposes. For example, a polyfunctional acrylate monomer may be added to enhance the strength of the insulating layer, or inorganic or organic particles may be added to enhance the strength of the insulating layer and improve the electrical properties.

The “insulating resin” as used in the invention refers to a resin having sufficient insulating properties to enable the use in known insulating films and insulating layer, and may be applied to the invention even if it is not a complete insulator as long as it has the insulating properties suitable to the purpose.

Specific examples of the insulating resin include a themosetting resin, a thermoplastic resin and a mixture thereof. Examples of the thermosetting resin include epoxy resin, phenol resin, polyimide resin, polyester resin, bismaleimide resin, polyolefin resin, and isocyanate resin.

Examples of the thermoplastic resin that may be used include phenoxy resin, polyethersulfone, polysulfone, polyphenylene sulfone, polyphenylene sulfide, polyphenyl ether, polyetherimide, liquid crystal polymer, fluororesin, and polyphenylene ether resin, and modified resins thereof.

Composite materials of the resins and other components may also be used in the insulating resin composition in order to enhance the properties of the resin film such as mechanical strength, heat resistance, weather resistance, flame resistance, water resistance, and electrical characteristics. Exemplary materials that may be used to obtain the composite materials include paper, glass fiber, silica particles, phenol resin, polyimide resin, bismaleimide triazine resin, fluororesin and polyphenylene oxide resin.

In addition, the insulating resin composition may optionally include at least one filler used in a common resin material for circuit boards which is selected from among, for example, inorganic fillers such as silica, alumina, clay, talc, aluminum hydroxide and calcium carbonate and organic fillers such as cured epoxy resin, cross-linked benzoguanamine resin and cross-linked acrylic polymer. Of these, silica is preferably used as the filler.

The insulating resin composition may optionally further include at least one of various additives such as colorant, flame retardant, adhesion promoter, silane coupling agent, antioxidant and UV absorber.

Taking into account the application to semiconductor packages and various electrical circuit boards, the substrate 12 preferably has a surface roughness (mean surface roughness Rₐ) of up to 500 nm, more preferably up to 100 nm and even more preferably up to 50 nm. The surface roughness is preferably as small as possible and its lower limit is zero.

The surface roughness of the substrate is preferably as small as possible because the electrical loss during the RF power transmission is reduced in cases where the resulting plated layer is applied to patterned wiring.

The thickness of the substrate 12 may be appropriately selected according to the intended use without any particular limitation and, for example, the thickness is preferably at least 5 μm and more preferably at least 10 μm.

The shape of the substrate 12 may be appropriately selected according to the intended use without any particular limitation and an elongated shape is preferred.

The substrate 12 may not be included in the laminate 10. If the substrate 12 is not included, the resin complex to be described later is formed by a known method into a predetermined shape such as a sheet shape to obtain a substrate made of the resin complex and the plated layer 16 to be described later is formed thereon.

### [Resin Complex Layer]

The resin complex layer 14 includes the hydrophobic compound A having a functional group capable of interacting with a plating catalyst, its precursor or a metal, and the hydrophobic resin B incompatible with the hydrophobic compound A. In the resin complex layer 14, a phase-separated morphology is formed which includes the dispersed phase (microdomains) 20 made of the hydrophobic compound A and the continuous phase 18 made of the hydrophobic resin B, the hydrophobic compound A being exposed on at least part of the surface.

### [Continuous Phase and Dispersed Phase]

The continuous phase 18 is made of the hydrophobic resin B incompatible with the hydrophobic compound A, is the main component of the resin complex layer 14 and is mainly used to improve the adhesion to the substrate 12. On the other hand, the dispersed phase 20 made of the hydrophobic compound A carries the plating catalyst or its precursor to be described later and is used to improve the adhesion to the plated layer 16.

An island-in-the-sea morphology as shown in FIG. 1 is preferably formed with the continuous phase 18 and the dispersed phase 20. The island-in-the-sea morphology refers to a morphology in which a phase with a smaller volume is dispersed like islands floating in the sea and the dispersed phase has a particulate, spherical or ellipsoidal shape.

The resin complex layer 14 has the phase-separated morphology formed with the continuous phase 18 and the dispersed phase 20 and therefore, the adhesion between the resin complex layer 14 and the substrate 12 and also between the resin complex layer 14 and the plated layer 16 can be enhanced without deteriorating the surface shape of the substrate 12. The continuous phase 18 and the dispersed phase 20 are both hydrophobic and therefore the dispersed phase 20 has a smaller domain size (domain diameter) and a larger number of domains compared to the commonly used phase-separated morphology including a hydrophobic resin and a hydrophilic resin. Accordingly, an infinite number of domains of the dispersed phase 20 with smaller domain diameters are exposed on the upper surface side of the resin complex layer 14 and therefore the adhesion between the resin complex layer 14 and the plated layer 16 is further improved while suppressing unevenness in the adhesion. In addition, by appropriately controlling the content of the dispersed phase 20 in the continuous phase 18, the adhesion to the plated layer 16 can also be imparted without deteriorating the mechanical properties and heat resistance of the continuous phase 18.

The phase-separated morphology of the resin complex layer 14 may be a so-called gradient layer in which the ratio of the dispersed phase 20 increases toward the plated layer 16, that is, the upper surface side of the resin complex layer 14 and decreases toward the substrate 12, that is, the lower surface side of the resin complex layer 14.

As shown in FIG. 2, the dispersed phase 20 made of the hydrophobic compound A is exposed on part of the surface of the resin complex layer 14. In terms of obtaining better adhesion and further suppressing unevenness of the adhesion of the resin complex layer with the plated film, the dispersed phase 20 preferably has an average diameter (domain diameter) of 0.01 μm to 500 μm, more preferably 0.02 μm to 300 μm, even more preferably 0.05 μm to 100 μm and most preferably 0.1 μm to 50 μm. When the dispersed phase domain is circular in section, its diameter is used and when the dispersed phase domain is ellipsoidal in section, the major axis length is used as the diameter.

The average diameter (domain diameter) of the dispersed phase 20 is obtained by observing an arbitrarily selected portion on the upper surface of the resin complex layer 14 by an optical microscope or a scanning electron microscope (SEM), measuring the size of at least 20 domains of the dispersed phase 20 and calculating the average of the resulting measurements.

The area ratio of the dispersed phase 20 on the surface of the resin complex layer 14 is not particularly limited. The continuous phase made of the hydrophobic resin B and the dispersed phase made of the hydrophobic compound A for use in depositing a metal are present in mixture and therefore better adhesion is achieved between the hydrophobic resin B and the hydrophobic compound A and also between the whole resin complex and the metal while further suppressing the unevenness of the adhesion. In view of this, the dispersed phase 20 preferably accounts for 2 to 98%, more preferably 3 to 97%, even more preferably 5 to 95% and most preferably 10 to 90% per unit area (mm²) on the surface of the resin complex layer 14. When the area ratio of the dispersed phase 20 is too low, the area where deposition starts in the plating treatment to be described later is reduced, deposition takes time, and the adhesion between the plated layer and the resin complex capable of being plated may be reduced. When the area ratio of the dispersed phase 20 is too high, the mixing between the hydrophobic resin B and the hydrophobic compound A may be reduced to weaken the adhesion between them.

The area ratio of the dispersed phase 20 is determined by a method which involves taking images at arbitrary four surface portions of the resin complex layer 14 where plating is to be made (shot area of each portion: 1 mm²) by a scanning electron microscope (SEM) and determining the area ratio per unit area of the dispersed phase from the resulting images.

The number of domains of the dispersed phase 20 at the surface of the resin complex layer 14 is not particularly limited. The continuous phase made of the hydrophobic resin B and the dispersed phase of the hydrophobic compound A for depositing a metal are present in mixture and therefore better adhesion is achieved between the hydrophobic resin B and the hydrophobic compound A and also between the whole resin complex and the metal while further suppressing the unevenness of the adhesion. In view of this, the dispersed phase 20 more preferably has a larger number of domains as long as the area of the dispersed phase and the average diameter fall within preferred ranges.

The number of domains in the dispersed phase 20 is measured by a method which involves taking images at arbitrary four surface portions of the resin complex layer 14 where plating is to be made (shot area of each portion: 1 mm²) by a scanning electron microscope and counting the number of domains per unit area on the resulting images.

In the resin complex layer 14, the dispersed phase 20 may be dispersed in the whole of the layer, and the dispersed phase 20 is preferably disposed to a depth of up to 10 μm and more preferably up to 5 μm from the surface of the resin complex layer 14.

The weight ratio between the hydrophobic compound A and the hydrophobic resin B in the resin complex layer 14 is appropriately adjusted so that the resin complex layer 14 may have the above-described phase-separated morphology. The continuous phase of the hydrophobic resin B and the dispersed phase of the hydrophobic compound A for depositing a metal are present in mixture and therefore better adhesion is achieved between the hydrophobic resin B and the hydrophobic compound A and also between the whole resin complex and the metal while further suppressing the unevenness of the adhesion. In view of this, the weight ratio of the hydrophobic compound A to the whole resin complex is preferably from 0.000001 to 0.7, more preferably from 0.00001 to 0.5 and even more preferably from 0.0001 to 0.3 with respect to the whole resin complex (1.0). When the weight of the hydrophobic compound A is too small, a sufficient amount of the hydrophobic compound A may not be dispersed at the surface of the resin complex layer. When the weight of the hydrophobic compound A is too large, the properties of the hydrophobic resin B may be deteriorated.

The thickness of the resin complex layer 14 is appropriately adjusted depending on the intended use and is preferably from 0.1 to 50 μm, more preferably from 0.2 to 30 μm and even more preferably 0.3 to 10 μm in terms of obtaining better adhesion and further suppressing the unevenness of the adhesion. However, the resin complex layer 14 is not particularly limited for the preferred thickness when the resin complex is singly molded and used.

In cases where the application to intended uses to be described later including printed circuit boards is to be taken into account, the surface of the resin complex layer 14 which does not contact the substrate 12 preferably has the smallest possible mean surface roughness Rₐ so that the surface may be flat. More specifically, the surface portion of the resin complex layer 14 on which the plated layer is to be formed preferably has a mean surface roughness Rₐ of 0.01 to 1.5 μm, more preferably 0.01 to 1.0 μm and even more preferably 0.1 to 0.5 μm. The surface roughness Rₐ may be measured by any known measurement means such as AFM.

The resin complex layer 14 may contain various additives as long as the effects of the invention are not impaired. Exemplary additives that may be contained include a flame retardant (e.g., phosphorus flame retardant), a diluent, a thixotropic agent, a pigment, an antifoaming agent, a leveling agent, a coupling agent, and a radical generator.

### [Plating Catalyst and its Precursor]

The resin complex layer 14 contains the hydrophobic compound A and the hydrophobic resin B as the main components but preferably contains a plating catalyst or its precursor. In particular, the plating catalyst or its precursor is preferably contained at least on the surface of the resin complex layer 14 but may be contained at the other portions than on the surface. It is particularly preferred for the plating catalyst or its precursor to be contained in the dispersed phase 20 made of the hydrophobic compound A. The plating catalyst or its precursor is omitted in FIGS. 1 and 2.

The plating catalyst and its precursor may be previously contained in the resin complex layer 14 or be applied after the preparation of the resin complex layer 14. More specifically, the resin complex layer 14 may be prepared by previously mixing the plating catalyst or its precursor into the material for forming the resin complex layer 14 (e.g., hydrophobic compound A). Alternatively, the plating catalyst or its precursor may be adsorbed onto the surface of the resin complex layer 14 by immersing the substrate 12 having the resin complex layer 14 formed thereon in a solution containing the plating catalyst or its precursor (plating catalyst solution).

The content of the plating catalyst, its precursor or the metal present to a depth of 2 μm from the surface of the resin complex layer 14 which does not contact the substrate 12, that is, from the surface of the resin complex layer 14 to be plated is preferably from 1 to 2,000 mg/m² and more preferably from 2 to 1,500 mg/m² in terms of obtaining better adhesion, further suppressing the unevenness of the adhesion and keeping the deposition by the plating and the stability of the plating bath.

The content of the plating catalyst or its precursor can be obtained in terms of milligram per meter square (mg/m²) by quantifying the concentration of the plating catalyst, its precursor or the metal by a mass spectrometer (ICP-MS) and dividing the resulting amount by the area within which the amount was obtained.

The plating catalyst or its precursor is preferably distributed to a depth of up to 2 μm (i.e., 0 to 2 μm), more preferably 0 to 1 μm and even more preferably 0 to 0.7 μm from the surface of the resin complex layer 14. The distribution depth may be appropriately adjusted within the foregoing range, for example, by immersing the resin complex layer in a solution containing the plating catalyst or its precursor to be described later and controlling the immersion time and the concentration of the plating catalyst. If the plating catalyst or its precursor is present within the above-defined area, the adhesion can be improved while maintaining the mechanical properties of the resin complex layer 14 itself and the amount of the expensive material such as the plating catalyst to be used can also be reduced.

The distribution of the plating catalyst or it precursor may be determined by checking the cross-sectional surface of the resin complex layer for the distribution state by TEM-EDX and observing it by Rutherford Backscattering (RBS) combined with a process of determining the amount of plating catalyst (e.g., Pd amount) from the elemental analysis of ash remaining after incineration of the resin heated until the complete volatilization.

The main components contained in the resin complex layer 14 are described below in detail.

### [Hydrophobic Compound A]

The hydrophobic compound A that may be used in the invention is a hydrophobic compound having a functional group capable of interacting with the plating catalyst, its precursor or the metal to be described later. The functional group is hereinafter also referred to as “interactive group.” The hydrophobic compounds A may be used singly or in combination of two or more.

The hydrophobic compound A of the invention may be in the form of any one of a hydrophobic monomer, a hydrophobic macromonomer, a hydrophobic oligomer and a hydrophobic polymer A′ as long as the hydrophobic compound A forms a phase-separated morphology with the hydrophobic resin B to be described later. Of these, the hydrophobic polymer A′ is preferred in terms of the film formability and easy control of the film thickness.

The molecular weight of the hydrophobic compound A of the invention is not particularly limited as long as it forms a phase-separated morphology with the hydrophobic resin B to be described later, and is preferably from 1,000 to 500,000, more preferably from 2,000 to 300,000 and most preferably from 5,000 to 150,000 in terms of more easily forming the phase-separated morphology.

The interactive group is preferably a non-dissociative functional group. The non-dissociative functional group refers to a functional group in which no proton is generated by dissociation. The functional group has the function of interacting with a plating catalyst, its precursor or a metal but has no high water absorbability or high hydrophilicity unlike the dissociative polar group (hydrophilic group) and therefore the adhesion force of the plated layer has few variations due to changes in humidity.

More specifically, the interactive group is preferably selected from among a group capable of forming a coordination bond with a metal ion, a nitrogen-containing functional group, a sulfur-containing functional group and an oxygen-containing functional group. More specific examples thereof include nitrogen-containing functional groups such as imide group, pyridine group, amide group, tertiary amino group, ammonium group, pyrrolidone group, amidino group, triazine ring structure-containing group, isocyanuric structure-containing group, nitro group, nitroso group, azo group, diazo group, azide group, cyano group, and cyanate group (R—O—CN); oxygen-containing functional groups such as ether group, carbonyl group, ester group, N-oxide structure-containing group, S-oxide structure-containing group, N-hydroxy structure-containing group, phenolic hydroxyl group, hydroxyl group and carbonate group; sulfur-containing functional groups such as thioether group, thioxy group, thiophene group, thiol group, sulfoxide group, sulfone group, sulfite group, sulfoximine structure-containing group, sulfoxinium salt structure-containing group and sulfonic ester structure-containing group; phosphorous-containing functional groups such as phosphine group, phosphate group, and phosphoramide group; groups containing halogen atoms such as chlorine and bromine; and unsaturated ethylene group. In an embodiment showing no dissociation because of the relation with the neighboring atom or atom group, imidazole group, urea group or thiourea group may be used. In addition, a compound capable of forming a complex such as an inclusion compound (cyclodextrin or crown ether) may be applied instead of the functional groups.

Of these, ether group (more specifically a structure represented by —O—(CH₂)ₙ—O— (n is an integer of 1 to 5)) or cyano group is particularly preferred and cyano group is more preferred in terms of high polarity and high adsorptivity on a plating catalyst.

In general, the water absorption tends to increase with increasing polarity. However, since cyano groups interact with each other in the resin complex layer so as to cancel out the polarity, the layer is made compact and the polarity of the resin complex layer is reduced as a whole, leading to a decrease in the water absorbability. By adsorbing the plating catalyst on the resin complex layer with the use of a good solvent in the step to be described later, the cyano groups are solvated to eliminate the interaction therebetween, whereby the cyano groups can interact with the plating catalyst. Therefore, the cyano group-containing resin complex layer is preferred in that it exhibits conflicting characteristics of low hygroscopicity and high interaction with the plating catalyst.

The interactive group is more preferably an alkylcyano group. The aromatic cyano group withdraws the electron from the aromatic ring and the unpaired electron donating ability which is important for the adsorption onto the plating catalyst is rather low, whereas the alkylcyano group is not attached to the aromatic ring and is therefore preferred in terms of the adsorption onto the plating catalyst.

The hydrophobic compound A for use in the invention may contain two or more types of interactive groups.

The hydrophobic compound A that may be used in the invention preferably meets the following Conditions 1 and 2 and more preferably all of the Conditions 1 to 4.

Condition 1: The saturated water absorption at 25° C. and 50% RH is from 0.01 to 10 wt %.
Condition 2: The saturated water absorption at 25° C. and 95% RH is from 0.05 to 20 wt %.
Condition 3: The water absorption after 1-hour immersion in 100° C. boiling water is from 0.1 to 30 wt %.
Condition 4: The surface contact angle formed with 5 μL of distilled water dropped and allowed to stand for 15 seconds at 25° C. and 50% RH is from 50 to 155°.

The saturated water absorption and the water absorption in the Conditions 1 to 3 can be measured by the following method.

First, a film of the hydrophobic compound A is prepared. The preparation method is not particularly limited and an example thereof includes a coating method which involves applying the hydrophobic compound dissolved in a predetermined solvent to the substrate to form a film thereon. The substrate having a film of the hydrophobic compound A formed thereon may be used to measure the water absorption according to the following method.

First of all, the resulting film is allowed to stand in a vacuum dryer to remove moisture in the film. Then, the film is allowed to stand in a constant temperature and humidity bath set to predetermined temperature and humidity in the case of the Conditions 1 and 2 and is immersed for 1 hour in a water bath containing 100° C. boiling water in the case of the Condition 3, and the saturated water absorption and water absorption are determined based on the measurement of the weight changes. The saturated water absorption in the Conditions 1 and 2 is the water absorption measured at a point in time when there was no change in the weight after the elapse of 24 hours. Even in the laminate having a film of the hydrophobic compound A separately formed on the substrate of which the weight change is previously known, the water absorption of the film of the hydrophobic compound A can also be determined by measuring the saturated water absorption and the water absorption of the laminate in the same manner as above and calculating the difference between the water absorption of the substrate and that of the laminate.

The contact angle in the Condition 4 can be measured by the following method.

First, a film of the hydrophobic compound A is prepared in the same manner as above and is stored in a constant temperature and humidity bath set to 25° C. and 50% RH. In a measurement room adjusted to 25° C. and 50% RH, 5 μL of distilled water is automatically dropped from a syringe of a surface contact angle meter (OCA20 available from Data Physics Corporation) on the film of the hydrophobic compound A in a stored sample, an image in the cross-sectional direction of the substrate is captured with a CCD camera into a personal computer, and the contact angle of the water droplet with respect to the film of the hydrophobic compound A is computed by the image analysis.

In a preferred embodiment, the hydrophobic compound A meets all of the Conditions 1′ to 4′.

Condition 1′: The saturated water absorption at 25° C. and 50% RH is from 0.01 to 5 wt %.
Condition 2′: The saturated water absorption at 25° C. and 95% RH is from 0.05 to 10 wt %.
Condition 3′: The water absorption after 1-hour immersion in 100° C. boiling water is from 0.1 to 20 wt %.
Condition 4′: The surface contact angle formed with 5 μL of distilled water dropped and allowed to stand for 15 seconds at 25° C. and 50% RH is from 55 to 155°.

The hydrophobic compound A of the invention may further have a polymerizable group. The polymerizable group is not particularly limited as long as it is a functional group which causes the polymerization to proceed under the irradiation with thermal or active energy rays to form a polymer. Examples of the polymerizable group include a radical polymerizable group, a cationic polymerizable group and an anionic polymerizable group. Specific examples thereof include vinyl group, vinyloxy group, allyl group, acryloyl group, methacryloyl group, oxetane group, epoxy group, isocyanate group, an active hydrogen-containing functional group and an active group in an azo compound. The polymerizable group is preferably contained because the reaction between the polymerizable groups further improves the strength of the resin complex layer and enhances the interaction between the hydrophobic compound A and the hydrophobic resin B thereby further enhancing the adhesion therebetween.

In a specific embodiment of the interactive group-containing hydrophobic compound A in the invention, the interactive group-containing hydrophobic monomers are illustrated below. These may be used singly or in combination of two or more. However, the present invention is not limited thereto.

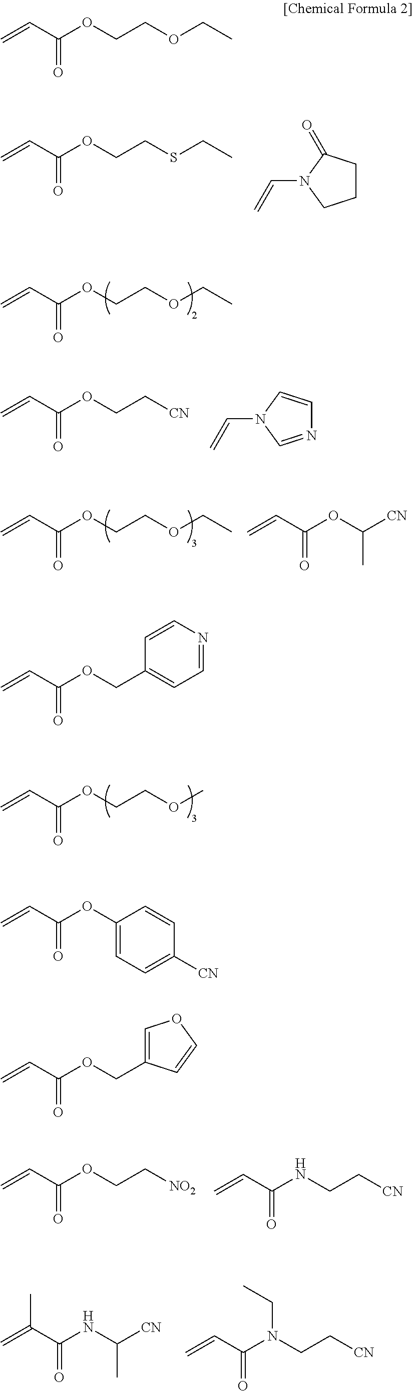

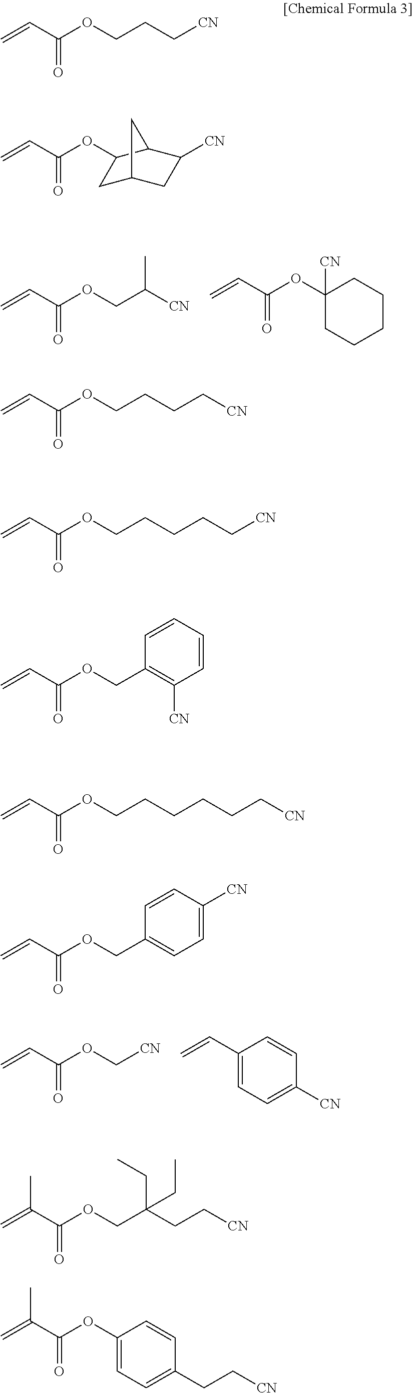

In the case of using any of the foregoing hydrophobic monomers, the hydrophobic monomer dispersed in the resin complex may be optionally polymerized by heat treatment or irradiation with light to obtain the resin complex layer having the hydrophobic polymer A′ dispersed as the dispersed phase.

The hydrophobic polymer A′ which is a preferred embodiment of the hydrophobic compound A for use in the invention is a polymer component which is insoluble in an aqueous dispersion medium such as water. Examples of the hydrophobic polymer A′ include homopolymers and copolymers obtained with the above-described interactive group-containing monomers. The type of the polymer skeleton of the hydrophobic polymer A′ is not particularly limited and exemplary polymers include an olefin polymer, a styrene polymer, an acrylic polymer, a polycarbonate polymer, a polyester polymer, an imide polymer, an amide polymer and a urethane polymer.

The content of the recurring unit derived from the interactive group-containing monomer in the hydrophobic polymer A′ is not particularly limited as long as good adhesion is achieved between the resin complex layer and the plated layer.

In cases where the above-described interactive group-containing monomer is used to form the hydrophobic polymer A′, the recurring unit derived from the interactive group-containing monomer is preferably contained in an amount of 5 to 100 mol %, more preferably 10 to 90 mol % and even more preferably 15 to 85 mol % with respect to all the recurring units in the hydrophobic polymer A′.

The weight-average molecular weight (Mw) of the hydrophobic polymer A′ is not particularly limited and is preferably from 1,000 to 500,000, more preferably from 2,000 to 300,000 and most preferably from 5,000 to 150,000 because the phase-separated morphology is easily formed and controlled.

The method of synthesizing the interactive group-containing hydrophobic polymer A′ is not particularly limited and examples thereof include a method in which a monomer having an interactive group is copolymerized with another monomer and a method in which an interactive group is introduced into a polymer. Commercially available products may also be used.

Examples of the monomer used with the interactive group-containing monomer include general polymerizable monomers such as diene monomer and acrylic monomer. Of these, unsubstituted alkyl acrylate monomers such as tert-butyl acrylate, 2-ethylhexyl acrylate, butyl acrylate, cyclohexyl acrylate, and benzyl methacrylate are preferred.

The method of manufacturing the hydrophobic polymer A′ containing an interactive group and a polymerizable group is not particularly limited and the hydrophobic polymer A′ may be synthesized as described below.

Exemplary methods include i) a method in which a monomer having an interactive group is copolymerized with a monomer having a polymerizable group, ii) a method in which a monomer having an interactive group is copolymerized with a monomer having a double bond precursor and a double bond is then introduced by a treatment with a base, and iii) a method in which a polymer having an interactive group is reacted with a monomer having a polymerizable group to introduce a double bond (i.e., introduce the polymerizable group).

The synthesis methods (ii) and (iii) are preferred in terms of the synthesis suitability.

### [Hydrophobic Polymer A′]

A preferred embodiment of the above-described hydrophobic compound A is a hydrophobic polymer A′ having a recurring unit represented by general formula (1):

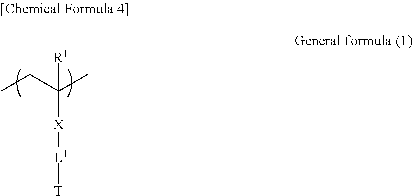

(wherein R¹ is a hydrogen atom or an optionally substituted alkyl group, X is a single bond or an optionally substituted divalent organic group, L¹ is an optionally substituted divalent organic group, and T is a functional group capable of interacting with a plating catalyst, its precursor or a metal).

In general formula (1), R¹ is a hydrogen atom or an optionally substituted alkyl group. Examples of the unsubstituted alkyl group include methyl group, ethyl group, propyl group and butyl group. Examples of the substituted alkyl group include methyl group, ethyl group, propyl group and butyl group substituted with methoxy group, hydroxy group, chlorine atom, bromine atom or fluorine atom. Of these, hydrogen atom and methyl group optionally substituted with hydroxy group or bromine atom are preferred.

In general formula (1), X is a single bond or an optionally substituted divalent organic group. Examples of the divalent organic group include an optionally substituted aliphatic hydrocarbon group, an optionally substituted aromatic hydrocarbon group, ester group, amide group, ether group and combination groups thereof.

Preferred examples of the optionally substituted aliphatic hydrocarbon group include methoxy group, ethylene group, propylene group and butylene group optionally substituted with methoxy group, hydroxy group, chlorine atom, bromine atom or fluorine atom.

Preferred examples of the optionally substituted aromatic hydrocarbon group include phenyl group optionally substituted with methoxy group, hydroxy group, chlorine atom, bromine atom or fluorine atom.

Of these, —(CH₂)ₙ— where n is an integer of 1 to 3 is preferred and —CH₂— is more preferred.

In general formula (1), L¹ is an optionally substituted divalent organic group. Examples of the divalent organic group include optionally substituted aliphatic hydrocarbon groups, and optionally substituted aromatic hydrocarbon groups.

L¹ is a linear, branched or cyclic alkylene group, an aromatic group, or a combination group thereof. The alkylene group may be further combined with the aromatic group via an ether group, an ester group, an amide group, a urethane group or a urea group. Of these, L¹ preferably contains in total 1 to 15 carbon atoms and is most preferably unsubstituted. The total number of carbon atoms in L¹ refers to the total number of carbon atoms included in the optionally substituted divalent organic group represented by L¹.

Specific examples thereof include methylene group, ethylene group, propylene group, butylene group and phenylene group which may be optionally substituted with methoxy group, hydroxy group, chlorine atom, bromine atom or fluorine atom, and combination groups thereof.

In general formula (1), T is a functional group capable of interacting with a plating catalyst, its precursor or a metal. More specifically, a group capable of forming a coordination bond with a metal ion, a nitrogen-containing functional group, a sulfur-containing functional group and an oxygen-containing functional group are preferred. More specific examples thereof include nitrogen-containing functional groups such as imide group, pyridine group, tertiary amino group, ammonium group, pyrrolidone group, amidino group, triazine ring, triazole ring, benzotriazole group, benzimidazole group, quinoline group, pyrimidine group, pyrazine group, nazoline group, quinoxaline group, purine group, triazine group, piperidine group, piperazine group, pyrrolidine group, pyrazole group, aniline group, alkylamine group structure-containing group, isocyanuric structure-containing group, nitro group, nitroso group, azo group, diazo group, azide group, cyano group, and cyanate group (R—O—CN); oxygen-containing functional groups such as phenolic hydroxyl group, hydroxyl group, carbonate group, ether group, carbonyl group, ester group, N-oxide structure-containing group, S-oxide structure-containing group and N-hydroxy structure-containing group; sulfur-containing functional groups such as thiophene group, thiol group, thiocyanuric acid group, benzothiazole group, mercaptotriazine group, thioether group, thioxy group, sulfoxide group, sulfone group, sulfite group, sulfoximine structure-containing group, sulfoxinium salt structure-containing group and sulfonic ester structure-containing group; phosphorous-containing functional groups such as phosphate group, phosphoramide group and phosphine group; groups containing halogen atoms such as chlorine atom and bromine atom; and unsaturated ethylene group. In an embodiment showing no dissociation because of the relation with the neighboring atom or atom group, imidazole group, urea group or thiourea group may be used.

Of these, ether group (more specifically a structure represented by —O—(CH₂)ₙ—O— (n is an integer of 1 to 5)) or cyano group is particularly preferred and cyano group is more preferred in terms of high polarity and high adsorptivity on a plating catalyst or its precursor.

In addition, a compound capable of forming a complex such as an inclusion compound, cyclodextrin or crown ether may be applied instead of the functional groups.

The content of the recurring unit represented by general formula (1) in the above-described hydrophobic polymer A′ is preferably from 5 to 100 mol %, more preferably from 10 to 90 mol % and even more preferably from 15 to 85 mol % with respect to all the recurring units (100 mol %) of the hydrophobic polymer A′ in terms of the interaction with the plating catalyst or its precursor.

The weight-average molecular weight (Mw) of the hydrophobic polymer A′ having the recurring unit represented by general formula (1) is not particularly limited as long as the hydrophobic polymer A′ may form a phase-separated morphology with the hydrophobic resin B to be described later, and is preferably from 1,000 to 500,000, more preferably from 2,000 to 300,000 and even more preferably from 5,000 to 150,000 in terms of the solubility in solvents and ease of handling.

A preferred example of the recurring unit represented by general formula (1) includes one represented by general formula (2):

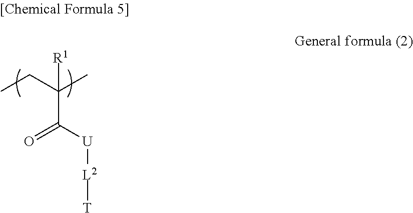

(wherein R² is a hydrogen atom or an optionally substituted alkyl group, U is an oxygen atom or NR′ (where R′ is a hydrogen atom or an alkyl group and preferably a hydrogen atom or an unsubstituted alkyl group having 1 to 5 carbon atoms), L² is an optionally substituted divalent organic group, and T is a functional group capable of interacting with a plating catalyst, its precursor or a metal).

R² in general formula (2) is as defined for R² in general formula (1) and is preferably a hydrogen atom.

L² in general formula (2) is as defined for L² in general formula (1) and is preferably a linear, branched or cyclic alkylene group, an aromatic group, or a combination group thereof.

Particularly in general formula (2), an embodiment in which the linkage moiety of L² with T is a divalent organic group having a linear, branched or cyclic alkylene group is preferred and an embodiment in which the divalent organic group contains in total 1 to 10 carbon atoms is more preferred.

In another preferred embodiment, the linkage moiety of L² with T in general formula (2) is a divalent organic group having an aromatic group and the divalent organic group more preferably contains in total 6 to 15 carbon atoms.

T in general formula (2) is as defined for T in general formula (1). T is a functional group capable of interacting with a plating catalyst, its precursor or a metal and is preferably a cyano group.

Another preferred example of the above-described hydrophobic compound A is a hydrophobic polymer A′ (copolymer) having recurring units represented by general formulas (1) and (3):

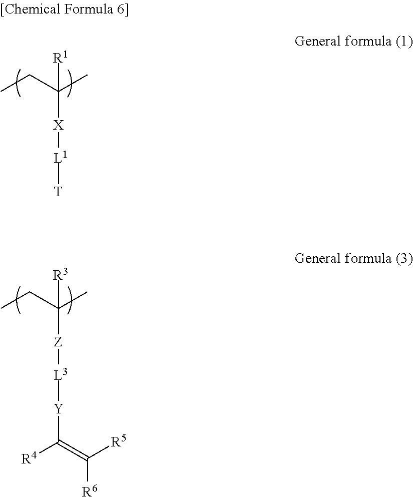

(in general formula (1), R¹ is a hydrogen atom or an optionally substituted alkyl group, X is a single bond or an optionally substituted divalent organic group, L¹ is an optionally substituted divalent organic group, and T is a functional group capable of interacting with a plating catalyst, its precursor or a metal, and in general formula (3), R³ to R⁶ are each independently a hydrogen atom or an optionally substituted alkyl group, Y and Z are each independently a single bond or an optionally substituted divalent organic group, and L³ is an optionally substituted divalent organic group).

The recurring unit represented by general formula (1) is as defined above.

In general formula (3), R³ to R⁶ are each independently a hydrogen atom or an optionally substituted alkyl group. The respective groups represented by R³ to R⁶ are the same as the groups represented by R¹ in general formula (1), and the preferable embodiments are also the same.

In general formula (3), Y and Z are each independently a single bond or an optionally substituted divalent organic group. The respective groups represented by Y and Z are the same as the groups represented by X in general formula (1), and the preferable embodiments are also the same.

In general formula (3), L³ is an optionally substituted divalent organic group. The respective groups represented by L³ are the same as the groups represented by L¹ in general formula (1).

L³ is preferably a divalent organic group having a urethane bond or a urea bond and more preferably a divalent organic group having a urethane bond. L³ even more preferably contains in total 1 to 9 carbon atoms. The total number of carbon atoms in L³ refers to the total number of carbon atoms included in the optionally substituted divalent organic group represented by L³.

More specifically, L³ preferably has a structure represented by general formula (3-1) or (3-2).

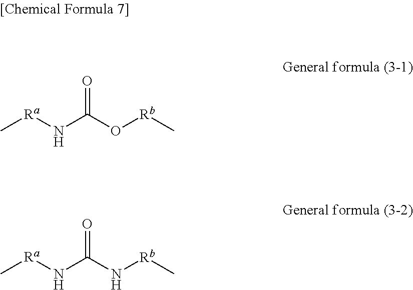

In general formulas (3-1) and (3-2), R^{a} and R^{b} are each independently a divalent organic group formed with at least two atoms selected from the group consisting of carbon atom, hydrogen atom and oxygen atom. Preferred examples thereof include optionally substituted methylene, ethylene, propylene and butylene groups, ethylene oxide group, diethylene oxide group, triethylene oxide group, tetraethylene oxide group, dipropylene oxide group, tripropylene oxide group, and tetrapropylene oxide group.

A preferred example of the recurring unit represented by general formula (3) includes one represented by general formula (4):

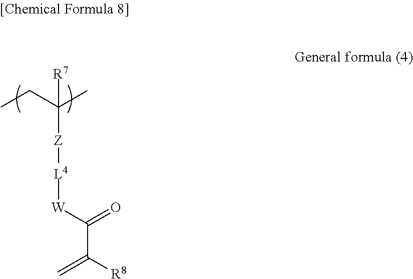

(wherein R⁷ and R⁸ are each independently a hydrogen atom or an optionally substituted alkyl group, Z is a single bond or an optionally substituted divalent organic group, W is an oxygen atom or NR (where R is a hydrogen atom or an alkyl group and preferably a hydrogen atom or an unsubstituted alkyl group having 1 to 5 carbon atoms), and L⁴ is an optionally substituted divalent organic group).

In general formula (4), R⁷ and R⁸ are each independently a hydrogen atom or an optionally substituted alkyl group. R⁷ and R⁸ are as defined above for R¹ in general formula (1) and the preferred embodiments are also the same.

Z in general formula (4) is as defined above for Z in general formula (3) and the preferred embodiment is also the same. L⁴ in general formula (4) is as defined above for L³ in general formula (3) and the preferred embodiment is also the same.

A preferred example of the recurring unit represented by general formula (4) includes one represented by general formula (5):

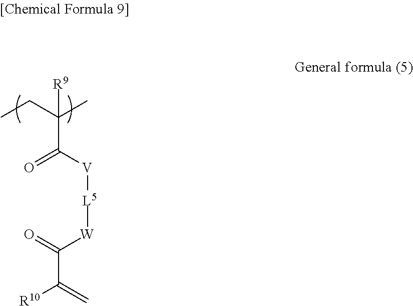

(wherein R⁹ and R¹⁰ are each independently a hydrogen atom or an optionally substituted alkyl group, V and W are each independently an oxygen atom or NR (where R is a hydrogen atom or an alkyl group and preferably a hydrogen atom or an unsubstituted alkyl group having 1 to 5 carbon atoms), and L⁵ is an optionally substituted divalent organic group).

In general formula (5), R⁹ and R¹⁰ are each independently a hydrogen atom or an optionally substituted alkyl group. R⁹ and R¹⁰ are as defined above for R¹ in general formula (1) and the preferred embodiments are also the same.

In general formula (5), L⁵ is an optionally substituted divalent organic group. L⁵ is as defined above for L³ in general formula (3) and the preferred embodiment is also the same.

In general formulas (4) and (5), W is preferably an oxygen atom.

In formulas (4) and (5), L⁴ and L⁵ are preferably an unsubstituted alkylene group or a divalent organic group having a urethane bond or a urea bond, more preferably a divalent organic group having a urethane bond, and most preferably contain in total 1 to 9 carbons.

The content of the recurring unit represented by general formula (1) in the above-described hydrophobic polymer A′ having the recurring units represented by general formulas (1) and (3) is preferably from 5 to 100 mol %, more preferably from 10 to 90 mol % and even more preferably 15 to 85 mol % with respect to all the recurring units (100 mol %) of the hydrophobic polymer A′ in terms of the interaction with the plating catalyst or its precursor.

In the hydrophobic polymer A′ having the recurring units represented by general formulas (1) and (3), the linking mode is not particularly limited and the recurring units represented by general formulas (1) and (3) may be alternately linked. In this case, one recurring unit may be linked to the other recurring unit or be repeated several times before being linked to the other recurring unit, which is then repeated several times. Alternatively, the recurring units may be randomly linked. The polymer may include a plurality of types of recurring units represented by general formulas (1) and (3).

The hydrophobic polymer A′ having the recurring units represented by general formulas (1) and (3) is a polymer having a polymerizable group and an interactive group as described above, and is preferably synthesized by the method (ii) in which a monomer having an interactive group is copolymerized with a monomer having a double bond precursor and a double bond is then introduced by a treatment with a base.

An example of the monomer having a double bond precursor includes a compound represented by formula (a):

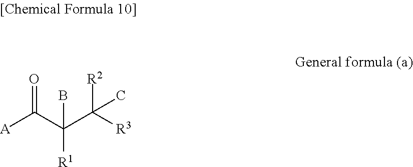

wherein A is an organic group having a polymerizable group, R¹ to R³ are each independently a hydrogen atom or a monovalent organic group, B and C are each a leaving group removed by an elimination reaction. The elimination reaction as used herein pulls out C under the action of a base to eliminate B. B and C are preferably eliminated as an anion and a cation, respectively.

Specific examples of the compound represented by formula (a) include the following:

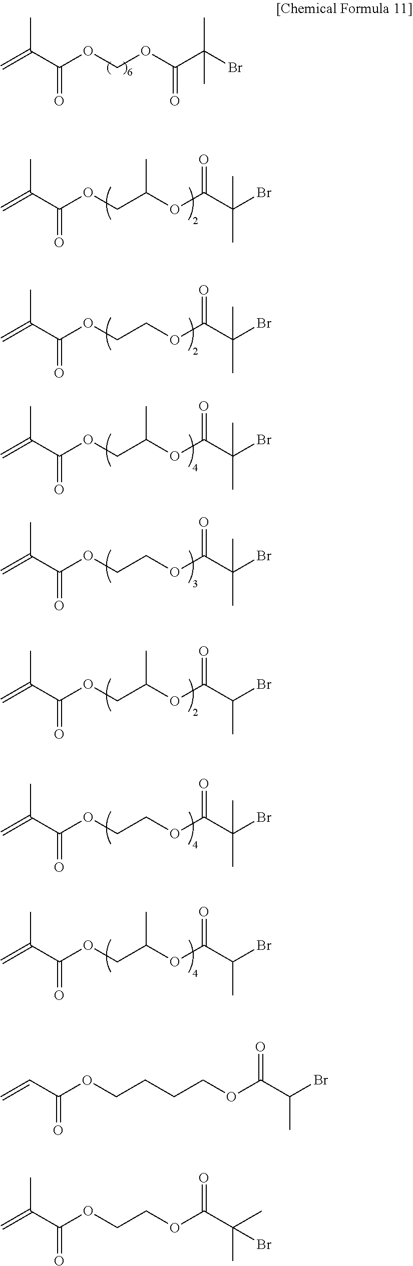

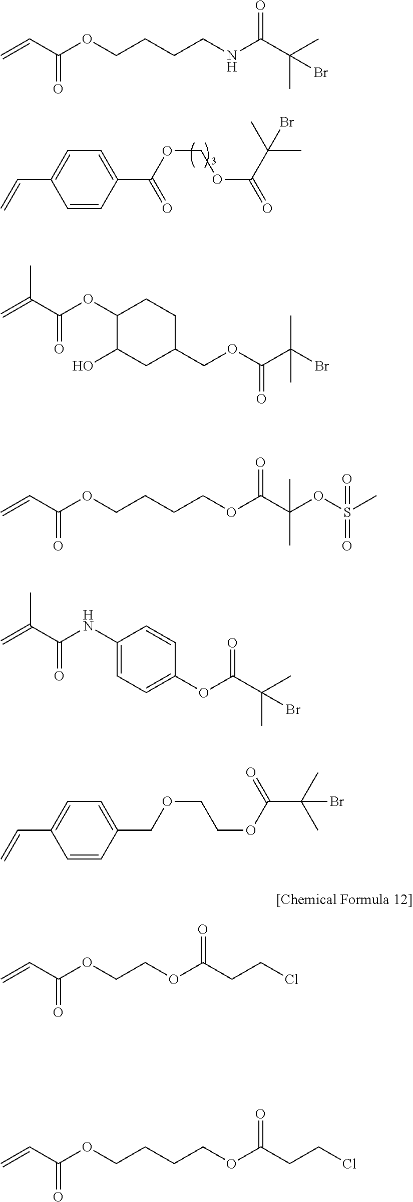

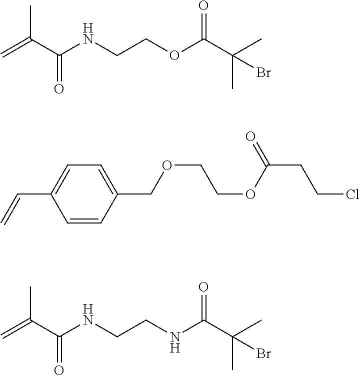

In order to convert the double bond precursor to the double bond, a process in which leaving groups represented by B and C are removed by the elimination reaction, in other words, a reaction in which C is pulled out by the action of a base to eliminate B is used as shown below.

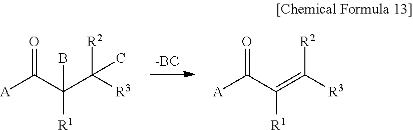

Preferred examples of the base for use in the elimination reaction include hydrides, hydroxides and carbonates of alkali metals, organic amine compounds and metal alkoxide compounds.

The base may be used in an amount equivalent to less than or more than the amount of the specified functional groups (leaving groups represented by B and C) in the compound.

A monomer having a reactive group such as carbonyl group, hydroxyl group, epoxy group or isocyanate group is used in the synthesis method iii) as the monomer having a reactive group for double bond introduction.

Examples of the carboxyl group-containing monomer include (meth)acrylic acid, itaconic acid, vinyl benzoate, Aronix M-5300, M-5400 and M-5600 (Toagosei Co., Ltd.), acrylic esters PA and HH (Mitsubishi Rayon Co., Ltd.), LIGHT-ACRYLATE HOA-HH (Kyoeisha Chemical Co., Ltd.) and NK Esters SA and A-SA (Nakamura Kagakukogyo Co., Ltd.).

Examples of the hydroxyl group-containing monomer that may be used include 2-hydroxyethyl (meth)acrylate, 4-hydroxybutyl (meth)acrylate, 2-hydroxypropyl (meth)acrylate, 2-hydroxybutyl (meth)acrylate, 1-(meth)acryloyl-3-hydroxy-adamantane, hydroxymethyl (meth) acrylamide, 2-(hydroxymethyl)-(meth)acrylate, methyl 2-(hydroxymethyl)-(meth)acrylate, 3-chloro-2-hydroxypropyl (meth)acrylate, 3,5-dihydroxypentyl (meth)acrylate, 1-hydroxymethyl-4-(meth)acryloylmethyl-cyclohexane, 2-hydroxy-3-phenoxypropyl (meth)acrylate, 1-methyl-2-acryloyloxypropylphthalic acid, 2-acryloyloxyethyl-2-hydroxyethylphthalic acid, 1-methyl-2-acryloyloxyethyl-2-hydroxypropylphthalic acid, 2-acryloyloxyethyl-2-hydroxy-3-chloropropylphthalic acid, Aronix M-554, M-154, M-555, M-155 and M-158 (Toagosei Co., Ltd.), BLEMMER PE-200, PE-350, PP-500, PP-800, PP-1000, 70PEP-350B and 55PET800 (NOF Corporation), and lactone-modified acrylates having the following structure:

CH₂═CRCOOCH₂CH₂[OC(═O)C₅H₁₀]ₙOH

(R is H or Me and n is 1 to 5).

Examples of the epoxy group-containing monomer that may be used include glycidyl (meth)acrylate, and CYCLOMER A and M (Daicel Chemical Industries, Ltd.).

Examples of the isocyanate group-containing monomer that may be used include Karenz AOI and MOI (Showa Denko K.K.).

Specific examples of the above-described hydrophobic polymer A′ are shown below but the invention is not limited thereto. The numerical values in the respective recurring units shown in the formulas represent the molar percentage of the recurring units.

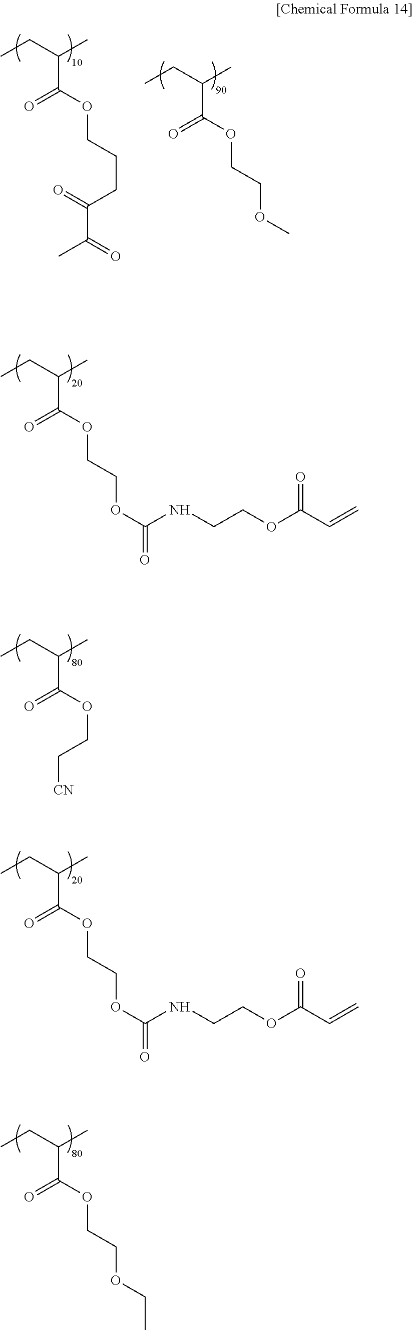

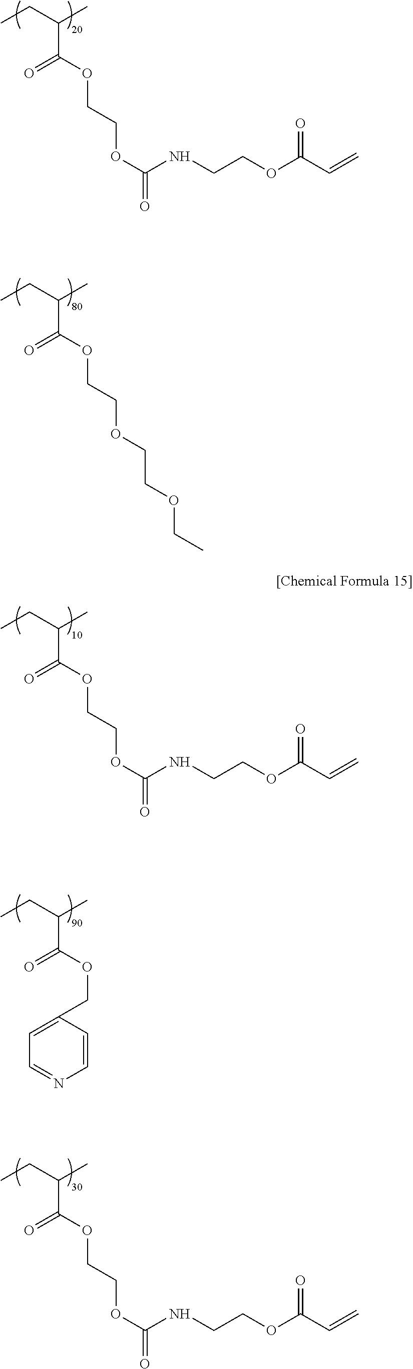

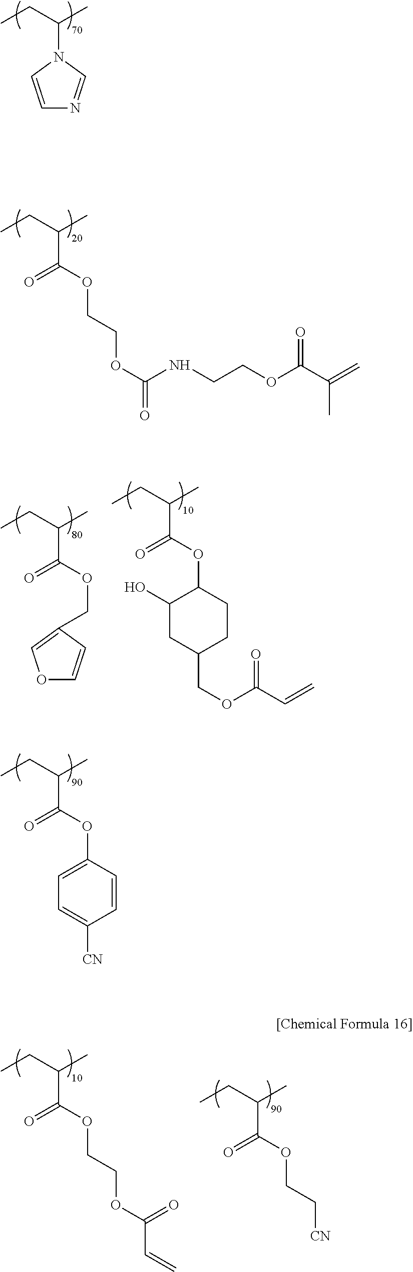

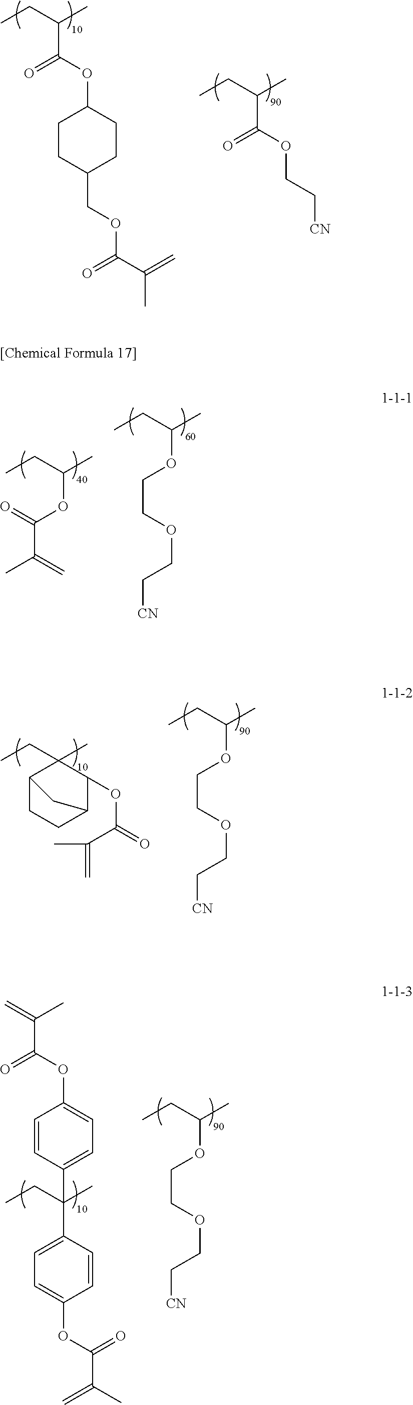

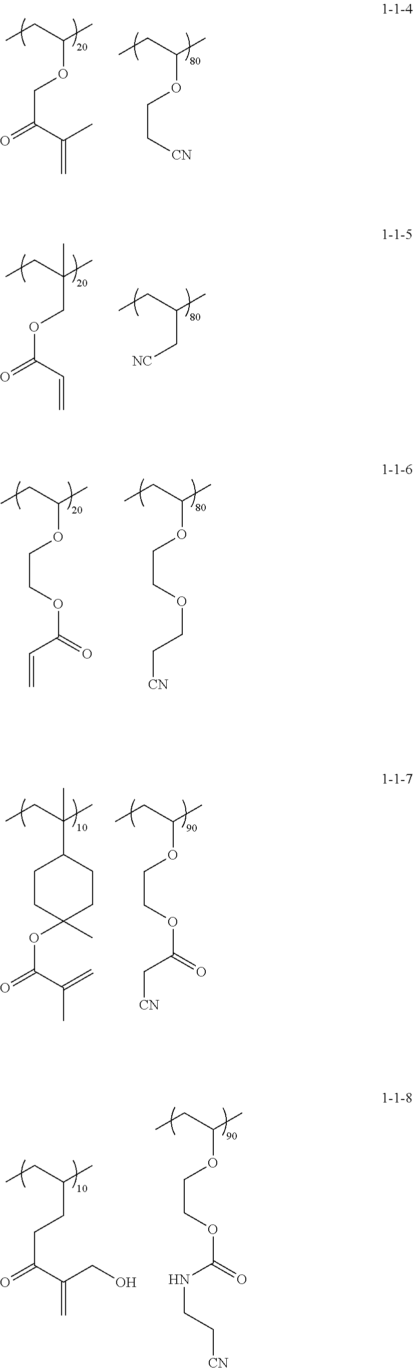

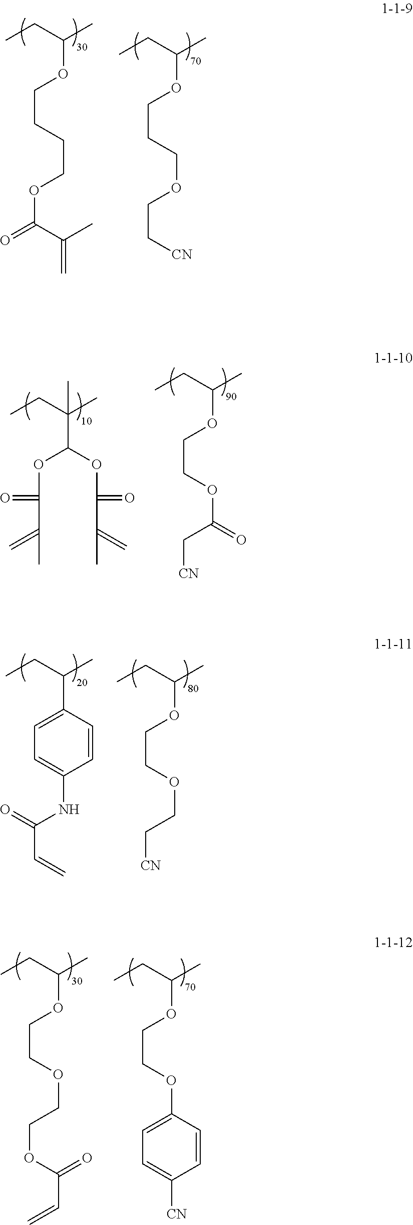

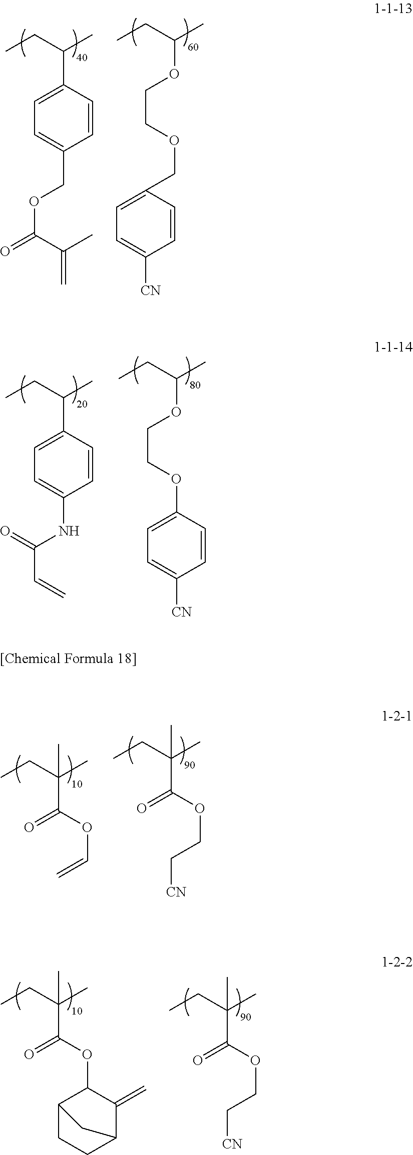

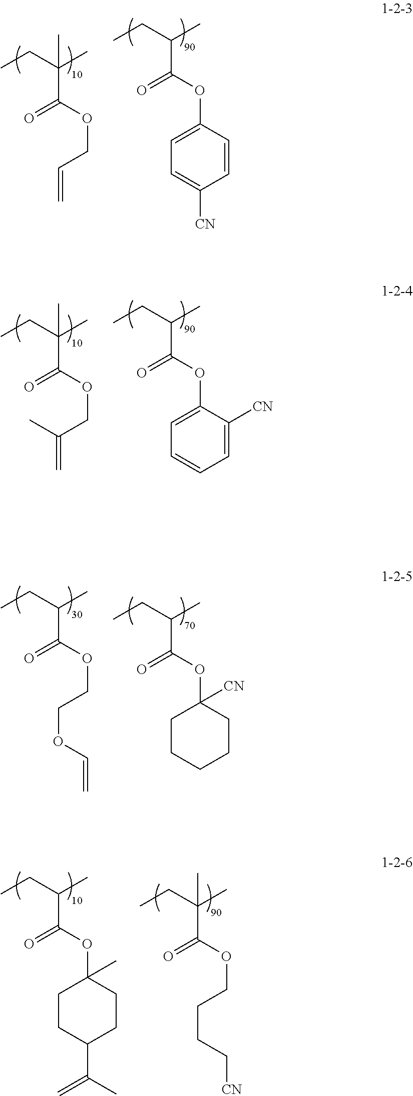

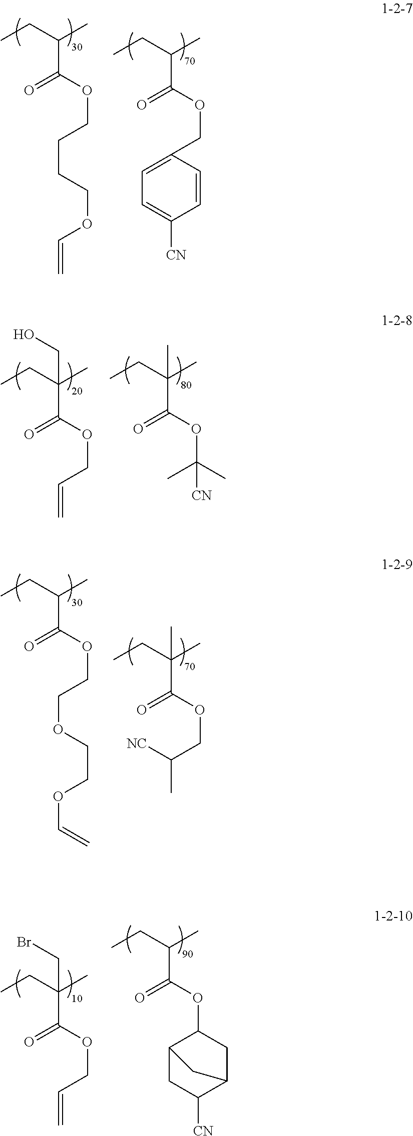

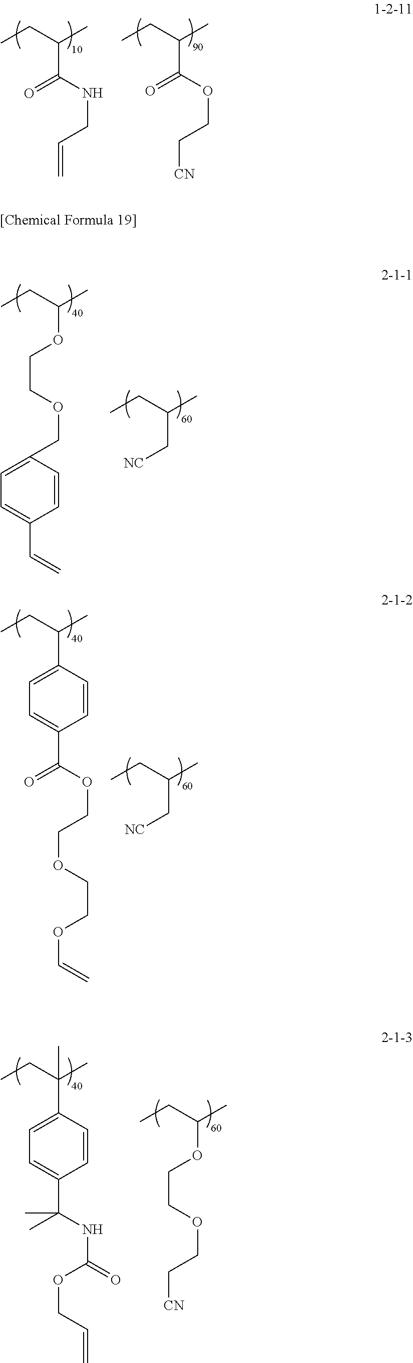

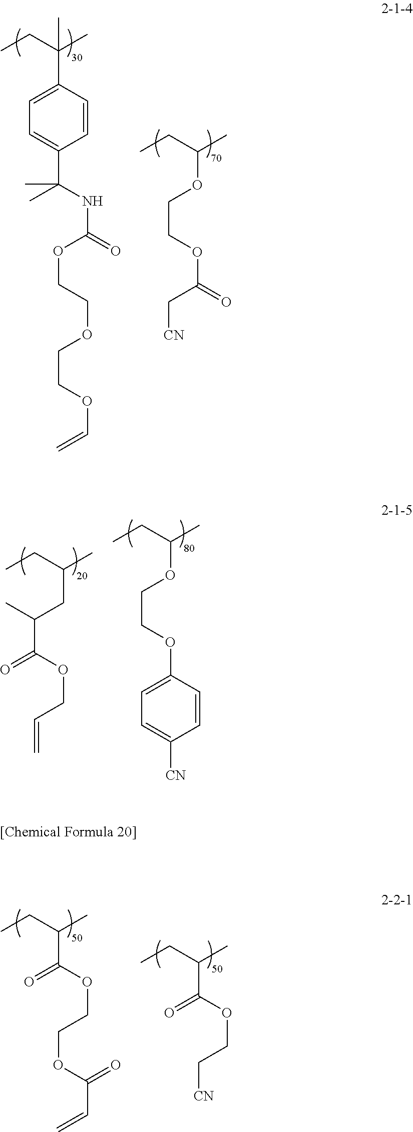

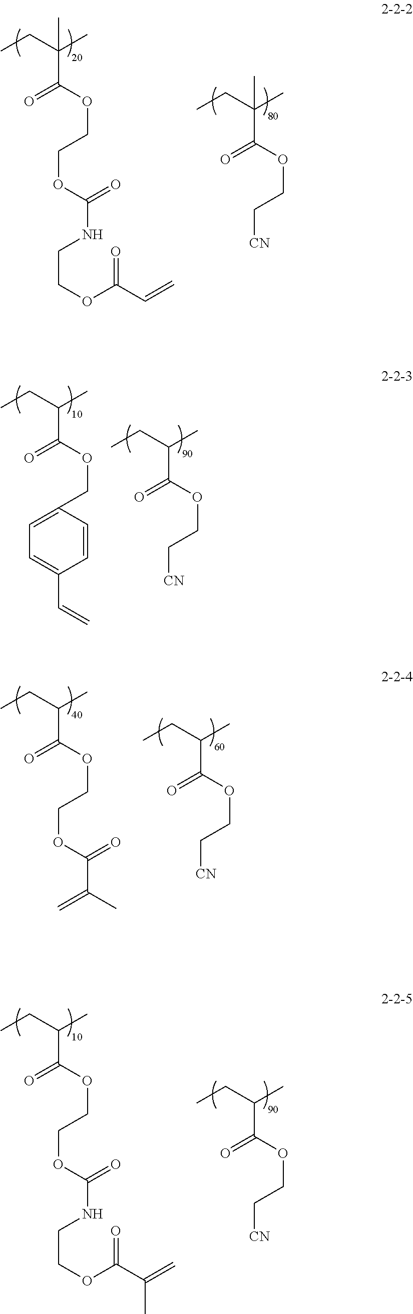

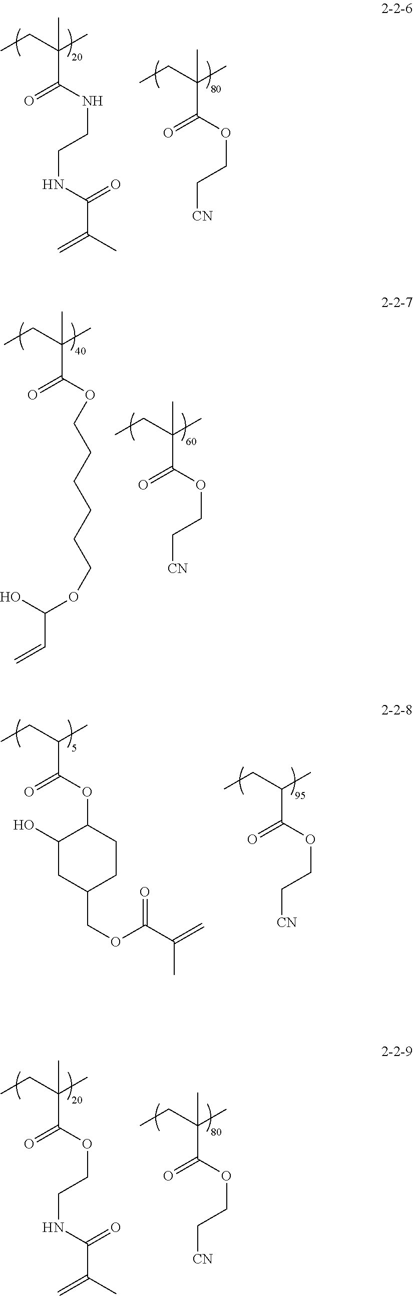

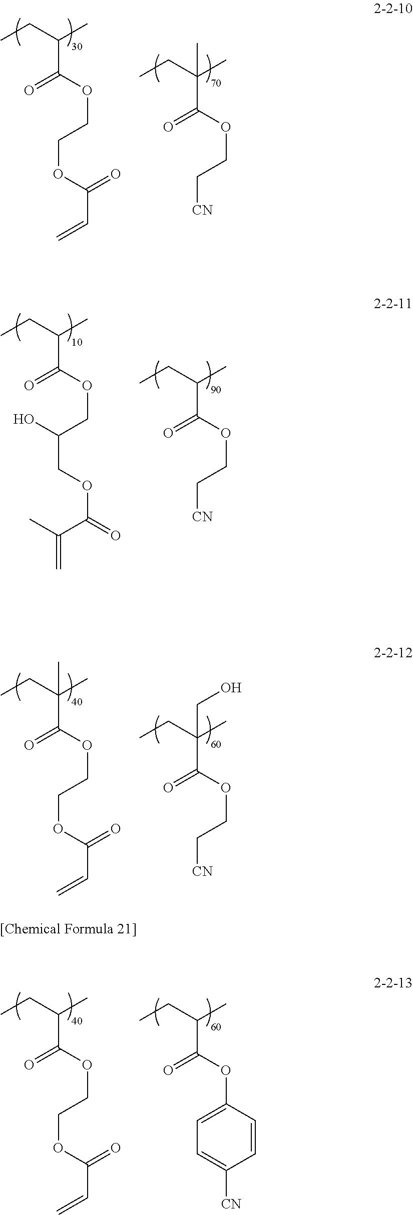

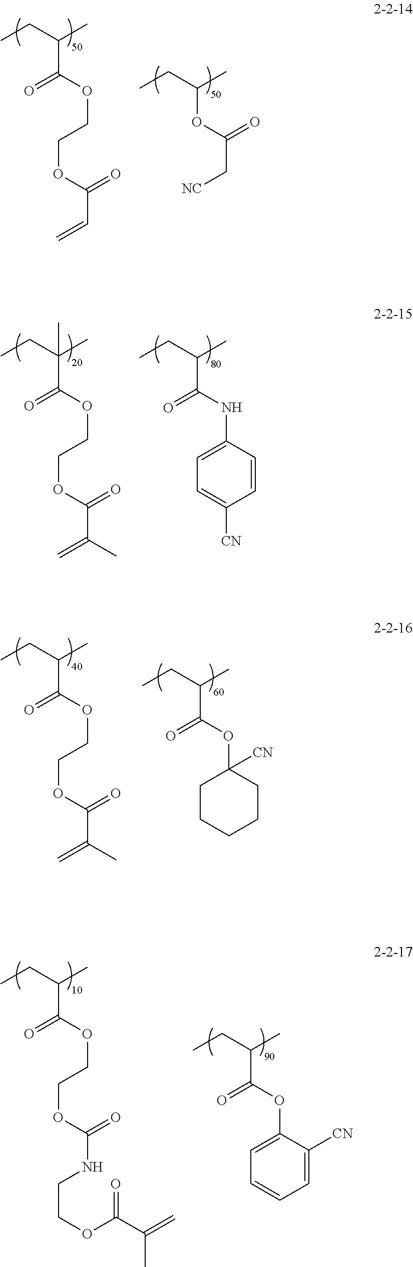

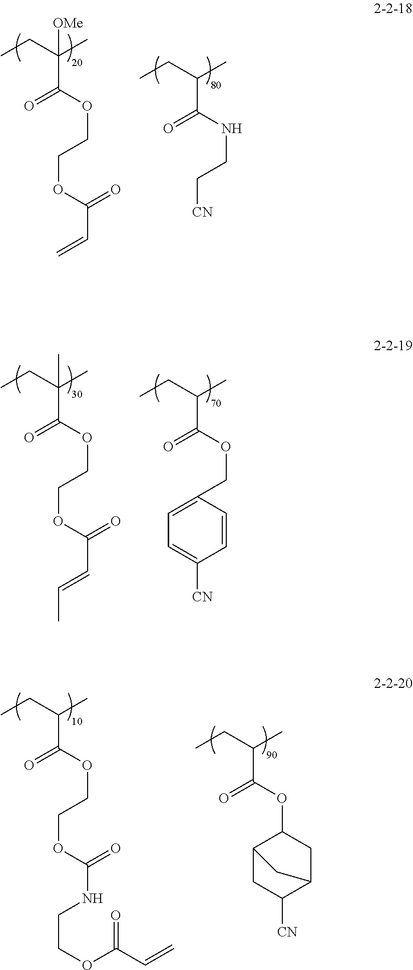

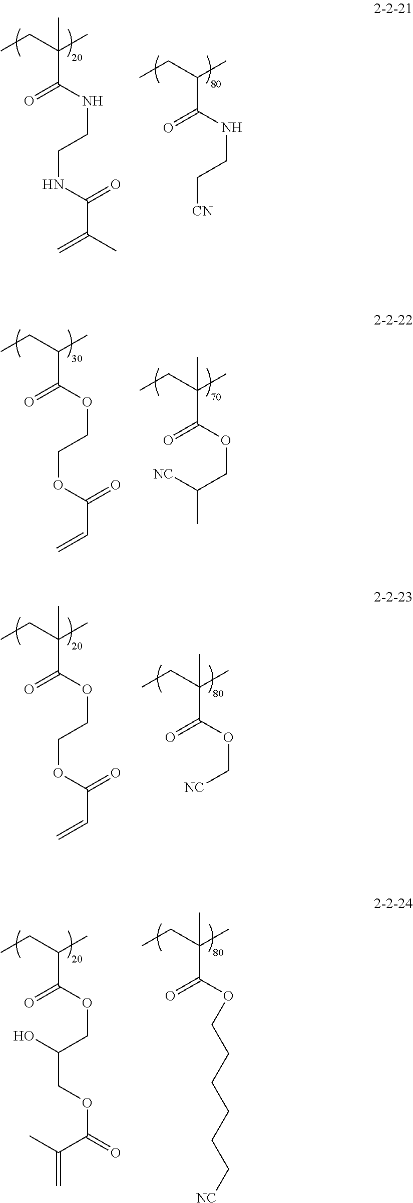

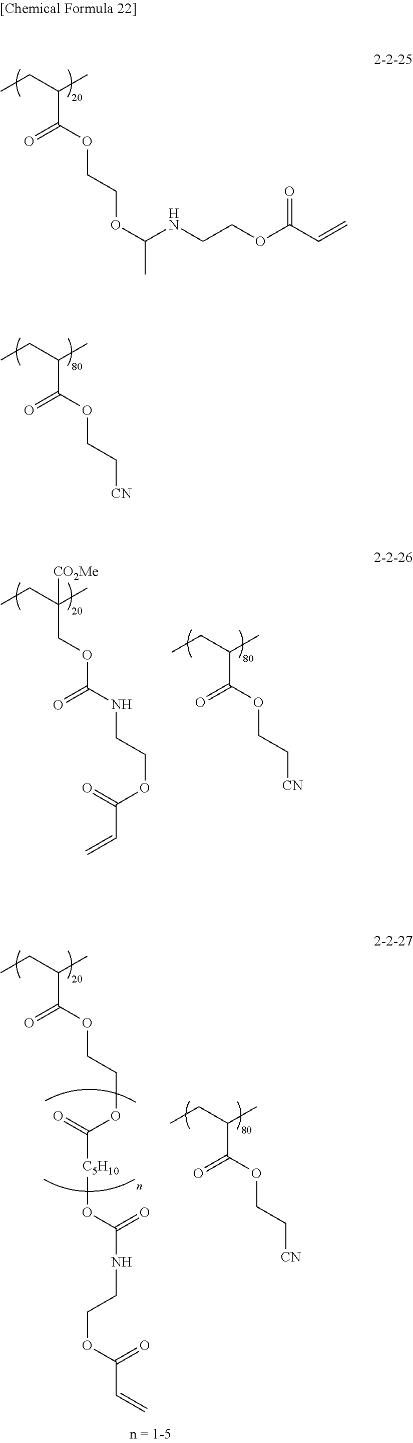

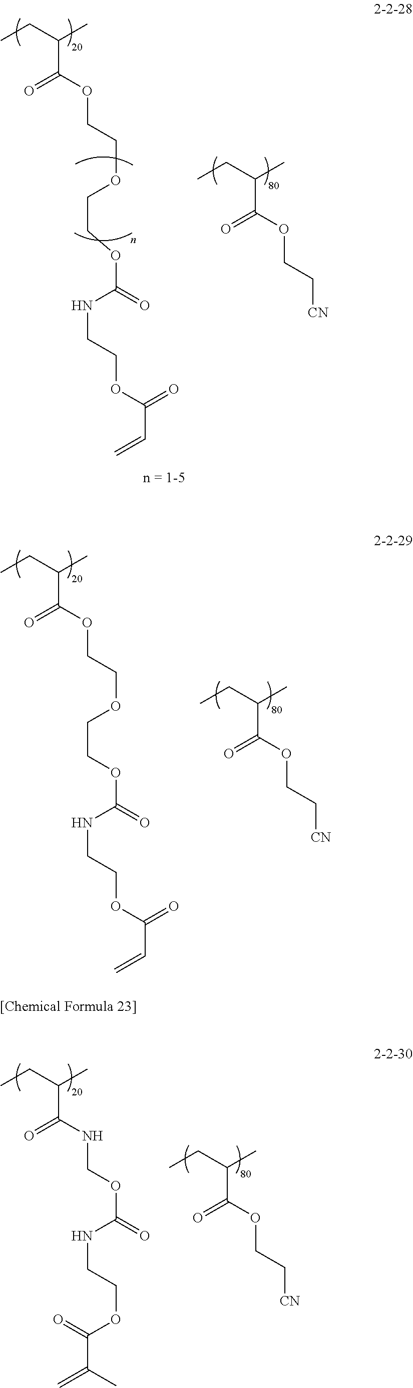

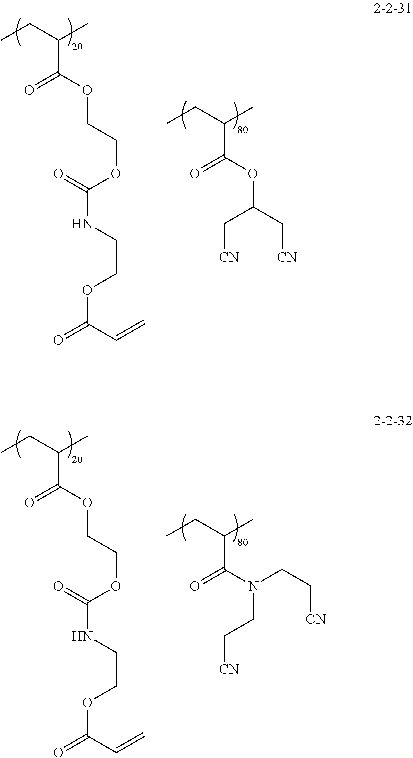

### [Hydrophobic Resin B]

The hydrophobic resin B for use in the invention is a resin component which is not compatible with the hydrophobic compound A and is insoluble in an aqueous dispersion medium.

The hydrophobic resin B is not particularly limited as long as it is not compatible with the above-described hydrophobic compound A. However, phase separation is difficult to achieve if the hydrophobic resin B is a polymer having the same skeleton except that it has a functional group capable of interacting with a plating catalyst, its precursor or a metal.

In general, in terms of lower water absorbability and higher mechanical strength, cellulose diacetate, cellulose triacetate, cellulose propionate, cellulose butyrate, cellulose acetate, cellulose nitrate, polyethylene terephthalate, polyethylene, polystyrene, polypropylene, polycarbonate, polyvinylacetal, polyimide, epoxy, bismaleimide resin, polyphenylene oxide, liquid crystal polymer, and polytetrafluoroethylene are preferred, and glass-epoxy substrate, polyimide, polycarbonate, ABS resin, polyamide resin, phenol resin, polyurea resin, polyurethane resin and epoxy resin are particularly preferred.

The weight-average molecular weight (Mw) of the hydrophobic resin B of the invention is not particularly limited.

As in the hydrophobic compound A, the hydrophobic resin B preferably meets the following Conditions 1 and 2 and more preferably all of the Conditions 1 to 4.

Condition 1: The saturated water absorption at 25° C. and 50% RH is from 0.01 to 10 wt %.
Condition 2: The saturated water absorption at 25° C. and 95% RH is from 0.05 to 20 wt %.
Condition 3: The water absorption after 1-hour immersion in 100° C. boiling water is from 0.1 to 30 wt %.
Condition 4: The surface contact angle formed with 5 μL of distilled water dropped and allowed to stand for 15 seconds at 25° C. and 50% RH is from 50 to 155°.

The measurement methods of the Conditions 1 to 4 are as described above.

The hydrophobic resin B may have the above-described interactive group at the end of the molecular chain.

### [Plating Catalyst]

Any plating catalyst may be used in the invention without particular limitation as long as it serves as the active nucleus during the electroless plating. For example, a metal which is capable of catalyzing the autocatalytic reduction reaction and which is known as a metal capable of electroless plating with lower ionization tendency than Ni may be used. Specific examples thereof include Pd, Ag, Cu, Ni, Fe and Co. Among these, metals capable of multidentate coordination are preferred. Pd is most preferred in terms of the number of types of functional group capable of coordination and the high catalytic ability.

The plating catalyst may be used as a metallic colloid. In general, the metallic colloid can be prepared by reducing metal ions in a solution containing a charged surfactant or a charged protective agent. The charge of the metallic colloid can be adjusted by the surfactant or protective agent used.

The size of the metallic colloid used is not particularly limited and is preferably the same as or smaller than the domain diameter of the separated phase in the above-described resin complex layer. At a larger size than the domain diameter, the resulting plated layer may be tarnished or the adhesion strength between the resin complex layer 14 and the plated layer 16 may be reduced.

### [Plating Catalyst Precursor]

The plating catalyst precursor can be used in the invention without any particular limitation as long as it may serve as the plating catalyst through a chemical reaction. Metal ions of the metals illustrated above for the plating catalyst are mainly used. The metal ions which serve as the plating catalyst precursor are turned through the reduction reaction into zero-valent metals serving as the plating catalyst. After the metal ion as the plating catalyst precursor is applied to the resin complex layer 14, the plating catalyst precursor may be separately turned into a zero-valent metal as the plating catalyst through the reduction reaction before being immersed in the electroless plating bath. Alternatively, the resin complex layer 14 including the plating catalyst precursor may be immersed in the electroless plating bath to be turned into a metal (plating catalyst) by the action of the reducing agent in the electroless plating bath.

The metal ion as the plating catalyst precursor is preferably applied to the resin complex layer 14 by the use of a metal salt. The metal salt used is not particularly limited as long as it dissolves in a suitable solvent to dissociate into a metal ion and a base (anion). Specific examples thereof include M(NO₃)ₙ, MClₙ, M_{2/n}(SO₄) and M_{3/n}(PO₄) (M represents a n-valent metal atom). The metal ions resulting from the dissociation of the metal salts may be advantageously used. Specific examples include Ag ion, Cu ion, Al ion, Ni ion, Co ion, Fe ion, and Pd ion. Among these, metals capable of multidentate coordination are preferred. Pd ion is most preferred in terms of the type of functional group capable of coordination and the high catalytic ability.

An example of the plating catalyst or its precursor that may be preferably used in the invention includes a palladium compound. The palladium compound serves as an active nucleus during the plating treatment to deposit the metal and functions as the plating catalyst (palladium) or its precursor (palladium ion). The palladium compound is not particularly limited as long as it contains palladium and serves as the nucleus during the plating treatment. Examples thereof include a palladium (II) salt, a palladium (0) complex and a palladium colloid.

Examples of the palladium salt include palladium acetate, palladium chloride, palladium nitrate, palladium bromide, palladium carbonate, palladium sulfate, bis(benzonitrile)dichloropalladium (II), bis(acetonitrile)dichloropalladium (II) and bis(ethylenediamine)palladium (II) chloride. Of these, palladium nitrate, palladium acetate, palladium sulfate and bis(acetonitrile)dichloropalladium (II) are preferred in terms of the ease of handling and solubility.

Examples of the palladium complex include a tetrakis(triphenylphosphine)palladium complex and a tris(benzylideneacetone)dipalladium complex.

The palladium colloid is composed of palladium (0) particles. The particle size is not particularly limited and is preferably from 5 to 300 nm and more preferably from 10 to 100 nm in terms of the stability in the liquid. The palladium colloid may optionally contain other metals such as tin. An example of the palladium colloid includes tin-palladium colloid. The palladium colloid may be synthesized by any known method or a commercially available product may be used. The palladium colloid can be prepared by reducing the palladium ion in a solution containing a charged surfactant or a charged protective agent.

The content of the palladium compound in the plating catalyst solution is preferably from 0.001 to 10 wt %, more preferably from 0.05 to 5 wt % and even more preferably from 0.10 to 1 wt % with respect to the total amount of the catalyst solution. At too low a content, deposition is difficult to take place in the plating to be described later, whereas at too high a content, the pattern plating properties and the etching residue removability may be impaired.

### [Plated Layer]

The plated layer 16 is formed on the above-described resin complex layer 14 and functions to add metallic luster or otherwise enhance the decorativeness and impart electrical conductivity. The plated layer 16 obtained in the invention has the effect that the strength of adhesion between the plated layer 16 and the resin complex layer 14 has few variations even under high temperature and high humidity conditions.

The metallic material making up the plated layer 16 is not particularly limited. Examples thereof include copper, nickel, tin, lead, silver, gold, palladium, platinum, zinc and chromium. These metals may be used in combination of two or more thereof. Of these, in terms of the electrical conductivity, copper, gold and silver are preferably used and copper is more preferably used in the printed circuit boards.

The thickness of the plated layer 16 is appropriately adjusted depending on the intended use. The thickness is preferably from 0.1 μm to 30 μm, more preferably from 0.15 μm to 25 μm and most preferably from 0.2 μm to 20 μm in terms of the flatness and thickness uniformity of the resulting plated layer.

The plated layer 16 may also be etched in a pattern shape by any known method to form a metal pattern. The metal pattern may also be obtained by forming the resin complex layer 14 in a pattern shape on the substrate 12 by a process such as an inkjet process or a printing process.

The laminate 10 which has the plated layer 16 with good adhesion may be advantageously used in various applications. Exemplary applications include electromagnetic wave protecting films, coating films, two-layer copper clad laminate (CCL) materials and electric wiring materials. The laminate 10 may also be applied to plating for adding metallic luster to various plastic products or to plating for enhancing the durability of plastic materials.

The laminate 10 having the plated layer 16 etched into a predetermined pattern may be used in various applications including semiconductor chips, various electrical circuit boards, flexible print circuits (FPC), chips on film (COF), tape automated bonding (TAB), antennas, multilayer circuit boards and mother boards.

The laminate having the substrate made of the resin complex and the plated layer formed thereon may also be advantageously used in the foregoing applications.

### [Manufacturing Method]

Next, a preferred method of manufacturing the above-described laminate 10 is described.

The preferred method of manufacturing the laminate 10 mainly includes the following steps:

[Step 1] a resin complex layer-forming step for forming on a substrate a resin complex layer including a hydrophobic compound

A having a functional group capable of interacting with a plating catalyst, its precursor or a metal, and a hydrophobic resin B incompatible with the hydrophobic compound A, the hydrophobic compound A being exposed on at least part of the surface of the resin complex layer;

[Step 2] a catalyst applying step for applying the plating catalyst or its precursor to the resin complex layer; and
[Step 3] a plating step for forming a plated layer on the resin complex layer having the plating catalyst or its precursor as obtained in the catalyst applying step.

Each step is described in detail below.

### [Resin Complex Layer-Forming Step]

The resin complex layer-forming step is a step for forming the above-described resin complex layer on the substrate. Exemplary processes for forming the resin complex layer on the substrate include a coating process in which a solution containing materials dissolved therein is applied to the substrate to form a coated layer thereon, an immersion process in which the substrate is immersed in a solution containing materials dissolved therein, and a melt extrusion process in which a molten material is extruded into a film by an extruder to form a film on the substrate, and a lamination process in which a previously formed resin complex film is laminated on the substrate. Of these, the coating process is preferred in terms of easy control of the layer thickness. In the practice of the invention, the materials making up the resin complex layer are both hydrophobic and therefore solvents for dissolving the resins are easily selected.

The solvent for dissolving the hydrophobic compound A and the hydrophobic resin B is selected as appropriate for the type of resin used, and examples thereof include ketone solvents such as acetone, methyl ethyl ketone and cyclohexanone; alcoholic solvents such as methanol, ethanol, propanol, ethylene glycol, glycerol and propylene glycol monomethyl ether; acids such as acetic acid; amide solvents such as formamide, dimethylacetamide and N-methylpyrrolidone; nitrile solvents such as acetonitrile and propylonitrile; ester solvents such as methyl acetate and ethyl acetate; and carbonate solvents such as dimethyl carbonate and diethyl carbonate.

The contents of the hydrophobic compound A and the hydrophobic resin B in the coating liquid may be selected as desired. The total content of the hydrophobic compound A and the hydrophobic resin B is preferably from 5 to 95 wt % and more preferably from 10 to 90 wt % with respect to the total coating solution in terms of the workability, coatability, drying time and working efficiency.

The coating solution may be prepared by mixing a solvent and the components according to a known method using a mixer, a bead mill, a pearl mill, a kneader or a roll mill. The various components may be added simultaneously or separately.

The method of applying the coating liquid is not particularly limited and examples thereof include known coating methods such as blade coating, rod coating, squeeze coating, reverse roll coating, transfer roll coating, spin coating, bar coating, air knife coating, gravure coating, and spray coating.

A step of heating the coated film may optionally be provided to remove the solvent in the coated film after the application. The drying temperature and time are appropriately selected.

### [Catalyst Applying Step]

The catalyst applying step is a step in which the plating catalyst (e.g., palladium) or its precursor (e.g., palladium ion) which serves as the nucleus in the plating treatment is applied to the resin complex layer obtained in the foregoing resin complex layer-forming step. In particular, in this step, the applied plating catalyst or its precursor is attached to (adsorbed onto) the interactive group of the hydrophobic compound A included in the resin complex layer according to the function of the interactive group. As described above, the plating catalyst or its precursor may be included not only in the dispersed phase of the hydrophobic compound A but also in the continuous phase of the hydrophobic resin B.

A metal serving as the plating catalyst or a metal salt serving as the electroless plating precursor may be applied to the resin complex layer, for example, by a method which involves preparing a dispersion of the metal in a suitable dispersion medium or a solution of the metal salt dissociated into a metal ion in a suitable solvent and contacting the dispersion or the solution (plating catalyst liquid) with the resin complex layer. More specifically, the dispersion or the solution is applied to the resin complex layer or the substrate having the resin complex layer formed thereon is immersed therein. In the immersion process, the resin complex layer is preferably immersed in the solution or the dispersion which is being stirred or shaken in order to keep the plating catalyst or its precursor which is close to and contact the surface of the resin complex layer at a constant concentration.

By contacting the plating catalyst or its precursor with the resin complex layer as described above, the plating catalyst or its precursor can be adsorbed onto the interactive group included in the resin complex layer by means of the interaction based on the intermolecular force such as van der Waals force or the interaction based on the coordination bond using lone-pair electrons.

The amount of adsorption and the extent of adsorption (extent in the depth direction from the layer surface) of the plating catalyst or its precursor in the resin complex layer can be controlled by appropriately adjusting the metal or metallic ion concentration in the dispersion or solution used or the contact time.

The content of the plating catalyst or its precursor in the dispersion or solution used is selected as appropriate for the intended use, and is preferably from 0.001 to 20 wt %, more preferably from 0.05 to 15 wt % and even more preferably from 0.1 to 10 wt % in terms of easy control of the amount of adsorption.

The time of contact with the resin complex layer is selected as appropriate for the intended use, and is preferably from 0.1 to 120 minutes and more preferably from 0.2 to 60 minutes in terms of the workability and the production efficiency.

An optimal solvent is appropriately selected for the solution containing the plating catalyst or its precursor according to the type of catalyst used. Water is commonly used as the solvent but the solvent used is preferably an organic solvent. The organic solvent contained contributes to enhancing the permeability of the resin complex layer made of the hydrophobic compound A and the hydrophobic resin B, whereby the plating catalyst or its precursor can be efficiently adsorbed onto the interactive group that the hydrophobic compound A has.

Of the organic solvents, a water-soluble organic solvent which is uniformly soluble in water at any ratio is preferred. Water-insoluble organic solvents may also be used by appropriately adjusting the amount of mixing with water.

Examples of the water-soluble organic solvent include a ketone solvent, an alcohol solvent, a nitrile solvent, an ether solvent, an ester solvent, an amine solvent, a thiol solvent and a halogen solvent. More specifically, acetone, dioxane, N-methylpyrrolidone, methanol, ethanol, isopropyl alcohol, diethylene glycol diethyl ether, diethylene glycol, glycerol, acetonitrile, acetic acid, triethylene glycol monomethyl ether, diethylene glycol dimethyl ether, and diethylene glycol diethyl ether may be used. Examples of the water-insoluble organic solvent include ester solvents such as ethyl acetoacetate, ethylene glycol diacetate, ethyl acetate and propyl acetate, phosphate ester solvents, paraffin solvents and aromatic solvents.

The content of the organic solvent in the solution containing the plating catalyst or its precursor is not particularly limited and is preferably from 0.1 to 70 wt %, more preferably from 1 to 50 wt % and even more preferably from 5 to 40 wt % with respect to the total amount of the solution. An organic solvent content within the foregoing range enables the permeability of the layer to the catalyst and the adsorptivity to be improved while suppressing undesired dissolution or erosion of the resin complex layer.

The adsorption of the plating catalyst or its precursor onto the resin complex layer according to the above-described method may be optionally followed by a step of cleaning the substrate surface with a predetermined solvent such as water (cleaning step) in order to remove extra plating catalyst or its precursor.

The solution for use in the cleaning is not particularly limited as long as it does not adversely affect the step to be described below, and a cleaning solution containing water as the main solvent and 0.5 to 40 wt % of organic solvent is more preferably used in terms of the removal efficiency.

### <Plating Step>

In the plating step, the resin complex layer to which the plating catalyst or its precursor was applied in the above-described catalyst applying step is plated to form the plated layer on the resin complex layer. The thus formed plated layer has excellent electrical conductivity and excellent adhesion to the resin complex layer.

Examples of the type of plating performed in this step include electroless plating and electroplating, and the type may be selected as appropriate for the function of the plating catalyst or its precursor. Of these, electroless plating is preferably performed in terms of improving the formability of a hybrid structure in the resin complex layer and the adhesion. Electroless plating may also be followed by electroplating so that the plated layer obtained may have a desired thickness.

### [Electroless Plating]

Electroless plating refers to an operation with which a metal is deposited by a chemical reaction using a solution in which metal ions to be deposited by plating are dissolved.

Electroless plating in this step is performed by cleaning the substrate having the plating catalyst applied thereto with water to remove extra plating catalyst (metal) and immersing the cleaned substrate in the electroless plating bath. A commonly known electroless plating bath may be used for electroless plating.

In cases where the substrate having the plating catalyst precursor applied thereto is immersed in the electroless plating bath with the plating catalyst precursor adsorbed onto or impregnated in the resin complex layer, the substrate is immersed in the electroless plating bath after removal of extra precursor (e.g., metal salt) by cleaning with water. In this case, reduction of the plating catalyst precursor and the subsequent electroless plating are performed in the electroless plating bath. A commonly known electroless plating bath may be used as above for electroless plating.

Reduction of the plating catalyst precursor can also be performed as a separate step preceding electroless plating by preparing the catalyst activating solution (reducing solution) instead of the form using the electroless plating solution as described above. The catalyst activating solution is a solution containing a reducing agent which can reduce the plating catalyst precursor (mainly metal ion) to a zero-valent metal, and the concentration of the reducing agent with respect to the total solution is generally in a range of 0.1 wt % to 50 wt % and preferably 1 wt % to 30 wt %. Examples of the reducing agent that may be used include boron reducing agents such as sodium borohydride and dimethylaminoborane, formamide and hypophosphorous acid.

In addition to the solvent, the general composition of the electroless plating bath mainly includes (1) a metal ion for plating, (2) a reducing agent, and (3) an additive for enhancing the stability of the metal ion (stabilizer). In addition to these components, this plating bath may also include known additives such as a stabilizer for the plating bath.

The solvent for use in this plating bath preferably contains an organic solvent which has high affinity for the resin complex layer with low water absorbability and high hydrophobicity (e.g., resin complex layer meeting the Conditions 1 and 2). The type and content of organic solvent may be adjusted according to the physical properties of the resin complex layer. It is particularly preferred to reduce the content of the organic solvent with increasing saturated water absorption of the resin complex layer in the Condition 1. More specifically, the content is adjusted as follows:

That is, in cases where the saturated water absorption in the Condition 1 is from 0.01 to 0.5 wt %, the content of the organic solvent in all the solvents within the plating bath is preferably from 20 to 80 wt %. In cases where the saturated water absorption in the Condition 1 is from 0.5 to 5 wt %, the content of the organic solvent in all the solvents within the plating bath is preferably from 10 to 80 wt %. In cases where the saturated water absorption in the Condition 1 is from 5 to 10 wt %, the content of the organic solvent in all the solvents within the plating bath is preferably from 0 to 60 wt %. In cases where the saturated water absorption in the Condition 1 is from 10 to 20 wt %, the content of the organic solvent in all the solvents within the plating bath is preferably from 0 to 45 wt %.

Examples of the organic solvent that may be preferably used in the plating bath include ketones such as acetone, and alcohols such as methanol, ethanol and isopropanol.

Copper, tin, lead, nickel, gold, palladium and rhodium are known metals that may be used in the electroless plating bath. Of these, copper and gold are particularly preferred in terms of the electrical conductivity.

A reducing agent and additives are selected as appropriate for the metal used. For example, the electroless copper plating bath contains a copper salt (CuSO₄), a reducing agent (HCOH) and additives such as a copper ion stabilizer (EDTA), a chelating agent (Rochelle salt) and a trialkanolamine.

The plating bath that may be used in the electroless CoNiP plating contains metal salts (cobalt sulfate and nickel sulfate), a reducing agent (sodium hypophosphite), and a complexing agent such as sodium malonate, sodium malate or sodium succinate.

The electroless palladium plating bath contains a metallic ion ((Pd(NH₃)₄)Cl₂), a reducing agent (NH₃, H₂NNH₂) and a stabilizer (EDTA).

These plating baths may contain components other than the above.

The thickness of the plated layer formed by electroless plating may be controlled by adjusting the metal ion concentration in the plating bath, the immersion time in the plating bath, and the temperature of the plating bath. The plated layer preferably has a thickness of at least 0.1 μm and more preferably 0.2 μm to 2 μm in terms of the electrical conductivity. However, in cases where the plated layer formed by electroless plating is used as the electrical conduction layer to perform electroplating to be described below, a film with a thickness of at least 0.1 μm should be formed uniformly.

The time of immersion in the plating bath is preferably from about 1 minute to about 6 hours and more preferably from about 1 minute to about 3 hours.

The cross-section of the plated film obtained as above by electroless plating is observed by a scanning electron microscope (SEM) and it was confirmed that the plating catalyst and the particulate plated metal are densely dispersed in the resin complex layer and the plated metal is further deposited on the resin complex layer. Since the interface between the resin complex layer and the plated film is in a hybrid state of the resin complex and the microparticles, good adhesion is achieved even when the interface between the resin complex layer (organic component) and the inorganic substance (catalyst metal or plated metal) is flat and smooth (for example, a 1 mm²-region has a surface roughness Rₐ of up to 1.5 μm).

### [Electroplating]

In this step, in cases where the plating catalyst or its precursor applied in the catalyst applying step functions as the electrode, the resin complex layer to which the plating catalyst or its precursor is applied can be subjected to electroplating.

The foregoing electroless plating may be followed by electroplating using the plated layer formed as the electrode. In this way, a new plated layer with a desired thickness can be easily formed based on the layer formed by electroless plating and having good adhesion to the substrate. The plated layer with a thickness suitable to the intended purpose can be formed by electroplating following electroless plating and therefore the laminate of the invention can be advantageously used in various applications.

Any conventionally known method may be used for electrolytic plating. Examples of the metal that may be used in electroplating in this step include copper, chromium, lead, nickel, gold, silver, tin, and zinc. In terms of the electrical conductivity, copper, gold and silver are preferred and copper is more preferred.

The thickness of the plated layer obtained by electroplating can be controlled by adjusting the concentration of the metal contained in the plating bath, current density or the like. When used in general electrical wiring, the layer preferably has a thickness of at least 0.5 μm and more preferably 1 to 30 μm in terms of the electrical conductivity.

The thickness of electrical wiring is reduced with decreasing line width of the electrical wiring or with miniaturization in order to maintain the aspect ratio. Therefore, the thickness of the plated layer formed by electroplating is not limited to the above-defined range but may be arbitrarily set.

In the invention, a metal or a metal salt derived from the plating catalyst or its precursor, and/or a metal deposited in the resin complex layer by electroless plating is formed in the resin complex layer as a fractal microstructure, whereby the adhesion between the plated layer and the resin complex layer can be further improved.

Stronger adhesion is achieved in cases where the ratio of metal in the region within a depth from the uppermost surface of the resin complex layer of 0.5 μm is 5 to 50 area % in a cross-sectional image of the substrate taken with a metallograph to determine the amount of metal present in the resin complex layer, and the interface between the resin complex layer and the plated layer has an arithmetic mean roughness Rₐ (ISO 4288 (1996)) of 0.01 to 0.5 μm.

According to another preferred embodiment of the method of manufacturing the laminate 10, the resin complex layer-forming step includes previously mixing the plating catalyst or its precursor into the material of the resin complex layer and forming the resin complex layer on the substrate by the above-described coating, extrusion molding or lamination. In the case of this method, the resin complex layer containing the plating catalyst or its precursor can be prepared in a single step without performing the above-described catalyst applying step and therefore this method is preferred in terms of the working efficiency and productivity.

In the case of this method, the laminate having the plated layer can be mainly manufactured by the following two steps:

[Step 1] a resin complex layer-forming step for forming on a substrate a resin complex layer including a hydrophobic compound A having a functional group capable of interacting with a plating catalyst, its precursor or a metal, a hydrophobic resin B incompatible with the hydrophobic compound A, and the plating catalyst or its precursor, the hydrophobic compound A being exposed on at least part of the surface of the resin complex layer; and
[Step 2] a plating step for performing electroless plating to form a plated layer on the resin complex layer to which the plating catalyst or its precursor was applied.

The plating step performed in this method is the same as that described above.

### EXAMPLES

The present invention is described below more specifically by way of examples. However, the present invention should not be construed as being limited to the following examples. Unless otherwise specified, the weight ratio is expressed by percentage or parts by weight.

### Example 1

### Synthesis Example 1

### Synthesis of Hydrophobic Compound A

First of all, Polymer A having a polymerizable group and an interactive group was synthesized as described below. To a three-neck flask with a volume of 500 mL were added 20 mL of ethylene glycol diacetate, 7.43 g of hydroxyethyl acrylate and 32.0 g of cyanoethyl acrylate, and the mixture was heated to 80° C. To the mixture was added dropwise a mixture solution containing 0.728 g of V-601 and 20 mL of ethylene glycol diacetate over 4 hours. After the dropwise addition, the mixture was reacted for 3 hours.

To the reaction solution were added 0.30 g of di-tert-butylhydroquinone, 1.04 g of U-600 (Nitto Kasei Co., Ltd.), 21.87 g of Karenz AOI (Showa Denko K.K.) and 22 g of ethylene glycol diacetate and the mixture was reacted at 55° C. for 6 hours. Then, to the reaction solution was added 4.1 g of methanol and the reaction was allowed to proceed for another 1.5 hours. After the end of the reaction, the solid was collected by reprecipitation with water to obtain Polymer A which was a specific polymerizable polymer having nitrile group as the interactive group. The ratio between the polymerizable group-containing recurring unit and the nitrile group-containing recurring unit (molar ratio) was 21:79. The molecular weight (Mw) in terms of polystyrene was 82,000 (Mw/Mn=3.4).

The resulting Polymer A (1 g) was dissolved in acetonitrile (3 g) to prepare a coating solution. The thus prepared coating solution was applied to a glass epoxy substrate (FR-4 available from Sumitomo Bakelite Co., Ltd.) to a thickness of 2 μm by spin coating and dried at 150° C. for 60 minutes.

The physical properties of the resulting polymer A were determined by the above-described methods and the following results were obtained.

Saturated water absorption at 25° C. and 50% RH: 1.3 wt %

Saturated water absorption at 25° C. and 95% RH: 3.3 wt %

Water absorption after 1-hour immersion in 100° C. boiling water: 7.4 wt %

Surface contact angle formed with 5 μL of distilled water dropped and allowed to stand for 15 seconds at 25° C. and 50% RH: 69.9°.

### (Resin Complex Layer-Forming Step)

The foregoing Polymer A (1 part by weight) as the hydrophobic compound A and ABS (430145 available from Aldrich) (5 parts by weight) as the hydrophobic resin B were dissolved in cyclohexanone (91 parts by weight) to prepare a resin mixture.

The thus prepared resin mixture was applied to a polycarbonate resin substrate (Mitsubishi Plastics, Inc.) to a thickness of 3 μm by spin coating and dried at 60° C. for 60 minutes.

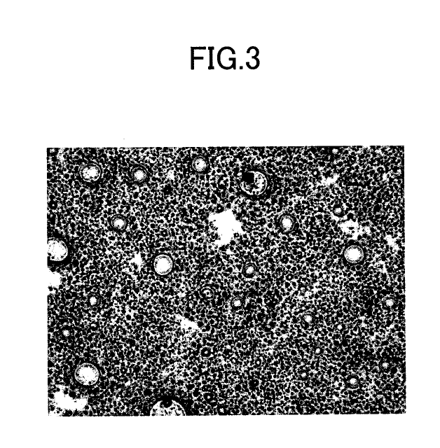

The surface of the resin complex layer obtained after the drying was observed by an optical microscope (BX-51 available from Olympus Corporation) and as a result, microdomains (dispersed phase) made of Polymer A with a diameter of 300 nm to 20 μm and an average diameter of 0.9 μm were confirmed (FIG. 3). The ratio of microdomains per unit area (mm²) was 10.1%. The surface of the resin complex layer on which the plated layer to be described later is to be formed had a mean surface roughness Rₐ of 0.08 μm.

### [Catalyst Applying Step]

A 0.05 wt % solution of palladium nitrate (water:acetone=8:2) was prepared as the solution containing the plating catalyst and filtered through a 0.5 μm-filter.

The substrate having the resin complex layer formed in the previous step was immersed in the prepared solution containing the plating catalyst for 30 minutes and the substrate surface was washed several times with acetone, then several times with water.

The cross-section of the resulting resin complex layer having the plating catalyst was observed by TEM-EDX and as a result, the plating catalyst (palladium) was found to be contained within a depth of 2 μm from the upper surface of the layer.

In addition, the amount of plating catalyst adsorbed onto the resulting resin complex layer having the plating catalyst as measured with a mass spectrometer (ICP-MS) was 30 mg/m².

### (Plating Step)

The electroless plating bath of the composition indicated below was used to perform electroless plating at 60° C. for 30 minutes on the substrate having the resin complex layer, the plating catalyst being applied thereto in the catalyst applying step. Copper was deposited on the whole surface of the resin complex layer. The resulting electroless copper plated layer had a thickness of 0.7 μm.

Composition of Electroless Plating Bath

| | | |
|---|---|---|
| Distilled water | 859 | g |
| Methanol | 850 | g |
| Copper sulfate | 18.1 | g |
| Disodium salt of ethylenediaminetetraacetic acid | 54.0 | g |
| Polyoxyethylene glycol (molecular weight: 1,000) | 0.18 | g |
| 2,2′-Bipyridyl | 1.8 | mg |
| 10% Aqueous ethylenediamine solution | 7.1 | g |
| 37% Aqueous formamide solution | 9.8 | g |

The plating bath of the foregoing composition was adjusted to a pH at 60° C. of 12.5 with sodium hydroxide and sulfuric acid.

The resulting plated layer was evaluated for the adhesion according to JIS H8504 and C5012 and as a result, the plated layer composed of 100 squares in a grid pattern was found not to come off but to have good adhesion.

### DESCRIPTION OF SYMBOLS

10 laminate
12 substrate
14 resin complex layer
16 plated layer
18 continuous phase
20 dispersed phase

1. A resin complex capable of being plated, which comprises: a hydrophobic compound A having a functional group capable of interacting with a plating catalyst, its precursor or a metal, and a hydrophobic resin B incompatible with the hydrophobic compound A, wherein the resin complex has a phase-separated morphology in which the hydrophobic compound A forms a dispersed phase and the hydrophobic resin B forms a continuous phase and the hydrophobic compound A is exposed on at least part of a surface of the resin complex.

2. The resin complex according to claim 1, wherein the dispersed phase comprising the hydrophobic compound A has an average diameter at the surface of the resin complex of 0.01 to 500 μm.

3. The resin complex according to claim 1, further comprising the plating catalyst or its precursor.

4. The resin complex according to claim 1, wherein the plating catalyst or its precursor is capable of existing within a depth of 2 μm from the surface of the resin complex.

5. The resin complex according to claim 1, wherein the hydrophobic compound A is a hydrophobic polymer A′ having a recurring unit represented by general formula (1): 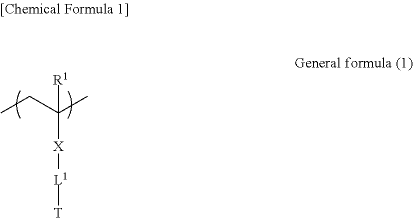
(wherein R¹ is a hydrogen atom or an optionally substituted alkyl group, X is a single bond or an optionally substituted divalent organic group, L¹ is an optionally substituted divalent organic group, and T is a functional group capable of interacting with the plating catalyst, its precursor or the metal).

6. A laminate comprising a substrate; and a resin complex layer comprising the resin complex according to claim 1 and formed on the substrate.

7. The laminate according to claim 6, wherein a surface portion of the resin complex layer on which a plated layer is to be formed has a mean surface roughness Rₐ of 0.01 to 1.5 μm.

8. The laminate according to claim 6, further comprising the plated layer formed on the resin complex layer.

9. A method of manufacturing a laminate having a plated layer, the method comprising:
a resin complex layer-forming step for forming on a substrate a resin complex layer including a hydrophobic compound A having a functional group capable of interacting with a plating catalyst, its precursor or a metal, and a hydrophobic resin B incompatible with the hydrophobic compound A, the hydrophobic compound A being exposed on at least part of a surface of the resin complex layer which does not contact the substrate;
a catalyst applying step for applying the plating catalyst or its precursor to the resin complex layer; and
a plating step for forming a plated layer on the resin complex layer having the plating catalyst or its precursor as obtained in the catalyst applying step.

10. The resin complex according to claim 2, further comprising the plating catalyst or its precursor.

11. The resin complex according to claim 2, wherein the plating catalyst or its precursor is capable of existing within a depth of 2 μm from the surface of the resin complex.

12. The resin complex according to claim 3, wherein the plating catalyst or its precursor is capable of existing within a depth of 2 μm from the surface of the resin complex.

13. The resin complex according to claim 2, wherein the hydrophobic compound A is a hydrophobic polymer A′ having a recurring unit represented by general formula (1): 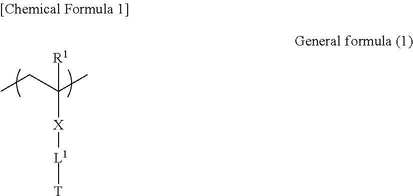
(wherein R¹ is a hydrogen atom or an optionally substituted alkyl group, X is a single bond or an optionally substituted divalent organic group, L¹ is an optionally substituted divalent organic group, and T is a functional group capable of interacting with the plating catalyst, its precursor or the metal).

14. The resin complex according to claim 3, wherein the hydrophobic compound A is a hydrophobic polymer A′ having a recurring unit represented by general formula (1): 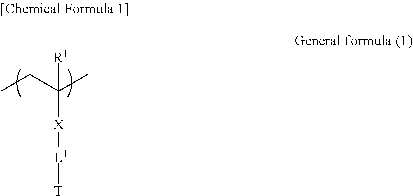
(wherein R¹ is a hydrogen atom or an optionally substituted alkyl group, X is a single bond or an optionally substituted divalent organic group, L¹ is an optionally substituted divalent organic group, and T is a functional group capable of interacting with the plating catalyst, its precursor or the metal).

15. The resin complex according to claim 4, wherein the hydrophobic compound A is a hydrophobic polymer A′ having a recurring unit represented by general formula (1): 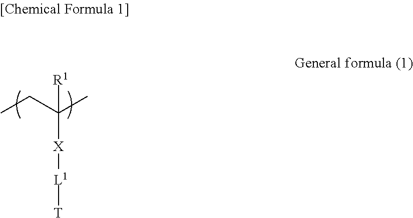
(wherein R¹ is a hydrogen atom or an optionally substituted alkyl group, X is a single bond or an optionally substituted divalent organic group, L¹ is an optionally substituted divalent organic group, and T is a functional group capable of interacting with the plating catalyst, its precursor or the metal).

16. A laminate comprising a substrate; and a resin complex layer comprising the resin complex according to claim 2 and formed on the substrate.

17. A laminate comprising a substrate; and a resin complex layer comprising the resin complex according to claim 3 and formed on the substrate.

18. A laminate comprising a substrate; and a resin complex layer comprising the resin complex according to claim 4 and formed on the substrate.

19. A laminate comprising a substrate; and a resin complex layer comprising the resin complex according to claim 5 and formed on the substrate.

20. The laminate according to claim 7, further comprising the plated layer formed on the resin complex layer.
